(19) United States
(12) Patent Application Publication
(10) Pub. No.: US 2026/0349748 A1
(43) Pub. Date: Nov. 5, 2026

(54) AI POWERED SYSTEM AND METHOD FOR ASSESSING ADOPTION MATURITY SCALE

(71) Applicant: TEACHERS INSURANCE AND ANNUITY ASSOCIATION OF AMERICA, New York, NY (US)

(72) Inventors: Rares Ioan Almasan, Phoenix, AZ (US); Sonam Jha, Skillman, NJ (US); Sastry Vsm Durvasula, Phoenix, AZ (US); Sriram Venkatesan, Princeton Junction, NJ (US); Geeta Pyne, San Jose, CA (US); Swatee Singh, Livingston, NJ (US); Thomas Matthew Verutes, Rockville Centre, NY (US)

(21) Appl. No.: 19/195,294

(22) Filed: Apr. 30, 2025

(51) Int. Cl. G06F 9/445; G06F 8/65; G06V 30/422

(52) U.S. Cl. CPC G06F 9/44505; G06F 8/65; G06V 30/422

(57) ABSTRACT

A method for evaluating and managing adoption maturity within a technology ecosystem is described herein. The method includes collecting one or more input data sets from a technology ecosystem, analyzing the one or more input data sets to obtain a plurality of parameters, evaluating the plurality of parameters using a scoring system to determine one or more scores for one or more criteria of the technology ecosystem, and generating an adoption maturity score for the technology ecosystem. The adoption maturity score may represent an extent to which the technology ecosystem is optimized.

### FIELD OF THE INVENTION

The present aspects relate to evaluating and managing adoption maturity within a technology ecosystem, and more particularly, to utilizing artificial intelligence and neural networks to forecast, predict, and classify adoption maturity, such as analyzing coding signals that define the adoption maturity score.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In the rapidly evolving landscape of technology, organizations must continuously assess and improve the maturity of their technology ecosystems to remain competitive and ensure efficient operations. One key measure of this readiness is the adoption maturity score, which quantifies the extent to which an organization's technology stack aligns with best practices (e.g., efficiency, optimizations, etc.), industry standards, and business objectives. The adoption maturity score serves as an indicator of an organization's ability to leverage its technological assets effectively, balancing innovation with maintainability and long-term sustainability.

Conventional approaches to assessing adoption maturity typically rely on ad-hoc evaluations, expert judgment, and fragmented assessments of individual components rather than a comprehensive, data-driven methodology. These manual and inconsistent methods introduce subjectivity, making it difficult for organizations to obtain an accurate, standardized measurement of their technological progress. Additionally, these conventional approaches require considerable investment in terms of time and tools, making it not only complex but also costly, making it a significant burden for organizations. As a result, organizations struggle to identify critical gaps in their technology ecosystem, delaying necessary improvements.

Given these challenges, there are opportunities to address adoption maturity by reducing the dependency on informal assessments and allowing organizations to more effectively allocate their resources towards innovation and development.

### BRIEF SUMMARY OF THE INVENTION

In some aspects, the techniques described herein relate to a method for evaluating and managing adoption maturity within a technology ecosystem. The method includes collecting, by one or more processors, one or more input data sets from a technology ecosystem, the one or more input data sets including at least a technical documentation data set, a well-architected framework (WAF) data set, and enterprise specific data set; analyzing, by the one or more processors, the one or more input data sets to obtain a plurality of parameters associated with the one or more input data sets; evaluating, by the one or more processors, the plurality of parameters using a scoring system to determine one or more scores for one or more criteria of the technology ecosystem based on the plurality of parameters; and generating, by the one or more processors, an adoption maturity score for the technology ecosystem based on the one or more scores for the one or more criteria of the technology ecosystem, where the adoption maturity score represents an extent to which the technology ecosystem is optimized.

In some aspects, the techniques described herein relate to a method, further including: identifying, by the one or more processors, one or more software or hardware updates to the technology ecosystem based on the one or more scores for the one or more criteria that would increase the adoption maturity score; and implementing, by the one or more processors, the one or more software or hardware updates in the technology ecosystem.

In some aspects, the techniques described herein relate to a method, where the one or more input data sets further includes a technical debt data set or a requirements data set.

In some aspects, the techniques described herein relate to a method, where collecting the one or more input data sets further includes analyzing application architecture diagrams and process flows of the technical documentation data set against the well-architected framework data set and the requirements data set.

In some aspects, the techniques described herein relate to a method, where evaluating the one or more criteria to determine the one or more scores further include analysis of scalability, security, and other factors defining the adoption maturity score.

In some aspects, the techniques described herein relate to a method, further including: generating, by the one or more processors, a local adoption maturity score based on the one or more scores for the one or more criteria of the technology ecosystem for parameters associated with a particular business unit; and generating, by the one or more processors, an enterprise adoption maturity score based on the one or more scores for the one or more criteria of the technology ecosystem for parameters associated with the enterprise, where generating the adoption maturity score further includes generating the adoption maturity score by combining the enterprise adoption maturity score and the local adoption maturity score.

In some aspects, the techniques described herein relate to a method, where analyzing the one or more input data sets to obtain a plurality of parameters includes: pre-processing, by the one or more processors, the one or more input data sets by applying the one or more input data sets to a trained machine learning model to classify information from the one or more input data sets into the plurality of parameters.

In some aspects, the techniques described herein relate to a method, where the technical documentation data set includes one or more of: technical documents, code repositories, architecture diagrams, security postures, environment scans, or disaster recovery files.

In some aspects, the techniques described herein relate to a method, where generating the adoption maturity score includes: for each of the one or more criteria, applying, by the one or more processors, the criterion to a first machine learning model to generate a respective score for the criterion; and applying, by the one or more processors, the respective scores for the one or more criteria to a second machine learning model to generate the adoption maturity score.

In some aspects, the techniques described herein relate to a method, further including: integrating, by the one or more processors, human feedback for continuous learning and adjustment of an adoption maturity assessment process.

In some aspects, the techniques described herein relate to a method, where the adoption maturity score is a category selected from at least one of: a silver category, a gold category, a platinum category, or a diamond category.

In some aspects, the techniques described herein relate to a method, where the technology ecosystem is initially assigned the silver category and generating the adoption maturity score includes: generating, by the one or more processors, the adoption maturity score such that the technology ecosystem progresses to a higher category one stage at a time based on the one or more scores for the one or more criteria associated with the higher category.

In some aspects, the techniques described herein relate to a method, further including: applying, by the one or more processors, one or more of: the adoption maturity score, the one or more input data sets, the plurality of parameters, the one or more criteria, or the one or more scores for the one or more criteria to a generative artificial intelligence model configured to generate responses to user queries regarding the adoption maturity; and providing, by the one or more processors, a response to a user query regarding the adoption maturity via a chatbot.

In some aspects, the techniques described herein relate to a computer system for evaluating and managing adoption maturity within a technology ecosystem. The computer system includes one or more processors, and a tangible, non-transitory memory coupled to the one or more processors and storing executable instructions thereon. When executed by the one or more processors, the instructions cause the computer system to: collect one or more input data sets from a technology ecosystem, the one or more input data sets including at least a technical documentation data set, a well-architected framework (WAF) data set, and enterprise specific data set; analyze the one or more input data sets to obtain a plurality of parameters associated with the one or more input data sets; evaluate the plurality of parameters using a scoring system to determine one or more scores for one or more criteria of the technology ecosystem based on the plurality of parameters; and generate an adoption maturity score for the technology ecosystem based on the one or more scores for the one or more criteria of the technology ecosystem, wherein the adoption maturity score represents an extent to which the technology ecosystem is optimized.

In some aspects, the techniques described herein relate to a computer system, where the instructions, when executed by the one or more processors, further cause the computer system to: identify one or more software or hardware updates to the technology ecosystem based on the one or more scores for the one or more criteria for the one or more criteria that would increase the adoption maturity score; and implement the one or more software or hardware updates in the technology ecosystem.

In some aspects, the techniques described herein relate to a computer system, where the instructions, when executed by the one or more processors, further cause the computer system to: generate a local adoption maturity score based on the one or more scores for the one or more criteria of the technology ecosystem for parameters associated with a particular business unit; and generate an enterprise adoption maturity score based on the one or more scores for the one or more criteria of the technology ecosystem for parameters associated with the enterprise, wherein the instructions to generate the adoption maturity score further causes the computer system to generate the adoption maturity score by combining the enterprise adoption maturity score and the local adoption maturity score.

In some aspects, the techniques described herein relate to a computer system, where the instructions to analyze the one or more input data sets to obtain a plurality of parameters further include instructions that, when executed by the one or more processors, further cause the computer system to: pre-process the one or more input data sets by applying the one or more input data sets to a trained machine learning model to classify information from the one or more input data sets into the plurality of parameters.

In some aspects, the techniques described herein relate to a computer system, where the instructions to generate the adoption maturity score further include instructions that, when executed by the one or more processors, further cause the computer system to: for each of the one or more criteria, apply the criterion to a first machine learning model to generate a respective score for the criterion; and apply the respective scores for the one or more criteria to a second machine learning model to generate the adoption maturity score.

In some aspects, the techniques described herein relate to a non-transitory computer-readable medium storing executable instructions for evaluating and managing adoption maturity within a technology ecosystem. When executed by one or more processors, the instructions cause the one or more processors to: collect one or more input data sets from a technology ecosystem, the one or more input data sets including at least a technical documentation data set, a well-architected framework (WAF) data set, and enterprise specific data set; analyze the one or more input data sets to obtain a plurality of parameters associated with the one or more input data sets; evaluate the plurality of parameters using a scoring system to determine one or more scores for one or more criteria of the technology ecosystem based on the plurality of parameters; and generate an adoption maturity score for the technology ecosystem based on the one or more scores for the one or more criteria of the technology ecosystem, where the adoption maturity score represents an extent to which the technology ecosystem is optimized.

In some aspects, the techniques described herein relate to a non-transitory computer-readable medium, where the instructions further cause the one or more processors to: identify one or more software or hardware updates to the technology ecosystem based on the one or more scores for the one or more criteria that would increase the adoption maturity score; and implement the one or more software or hardware updates in the technology ecosystem.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof.

FIG. 1 depicts an adoption maturity and quantification computing environment for evaluating and managing adoption maturity within a technology ecosystem, according to some aspects.

FIG. 2 depicts a flow diagram representing an overall method for generating an adoption maturity score, according to some aspects.

FIG. 3A illustrates a flow diagram for processing a technical documentation data set, according to some aspects.

FIG. 3B depicts a flow diagram for processing a well architecture framework (WAF) data set, according to some aspects.

FIG. 3C depicts a flow diagram for processing an enterprise specific data set, according to some aspects.

FIG. 3D depicts a flow diagram for processing a requirements data set, according to some aspects.

FIG. 4 depicts a flow diagram for predicting signal scores and an adoption maturity score, according to some aspects.

FIG. 5 illustrates an output system illustrating different ways of providing an adoption maturity score, according to some aspects.

FIG. 6 illustrates different adoption maturity score categories, according to some aspects.

FIG. 7 illustrates a flow diagram for a method for evaluating and managing adoption maturity within a technology ecosystem, according to some aspects.

FIG. 8A depicts a block-flow diagram outlining a method for building and applying an artificial intelligence model, according to some embodiments.

FIG. 8B illustrates a neural network-based model architecture for processing and analyzing data related to adoption maturity, according to some embodiments.

### DETAILED DESCRIPTION

In the rapidly evolving landscape of technology, organizations must continuously assess and refine their technology ecosystems to maintain operational efficiency and ensure long-term sustainability. Achieving an optimized and well-architected infrastructure is critical for mitigating risks associated with inefficiencies, outdated technologies, and inconsistent adoption of best practices. However, organizations often struggle with evaluating their technology stack in a standardized and quantifiable manner. Traditional approaches to assessing adoption maturity are highly complex, expensive, and time-consuming, requiring substantial investments in both financial resources and professional expertise. These conventional methods often rely on manual evaluations, expert judgment, and fragmented assessments of individual components, making it difficult to obtain a holistic and objective measurement of technological readiness. As a result, organizations may misallocate their technology budgets, delay critical improvements, and inadvertently accumulate technical debt, which in turn reduces their ability to scale, innovate, and maintain secure and resilient systems.

Addressing these challenges, the disclosed system and model introduce a novel approach to evaluate and manage adoption maturity within a technology ecosystem. This approach leverages technical documentation, adherence to a well-architected framework, enterprise-specific datasets, and other technological indicators to systematically evaluate an organization's technological landscape. By employing machine learning and data-driven analysis, the system classifies various signals (i.e., criteria) into quantifiable scores, ultimately generating a comprehensive adoption maturity score. The signals may be data points, metrics, or indicators that provide insights into the state, behavior, or performance of the technology ecosystem. For example, signals may include CPU utilization efficiency within cloud infrastructure, which measures the percentage of allocated computing resources actively used. Unlike conventional approaches, which require extensive manual effort and subjective evaluation, this system not only automates the maturity assessment process but also identifies specific signals that require optimization, providing actionable insights for improving the technology ecosystem in a cost-effective and scalable manner.

The techniques described herein include a computing system and methods for evaluating and managing adoption maturity within a technology ecosystem. This method employs one or more processors to collect one or more input data sets, analyze the one or more input datasets to obtain a plurality of parameters, evaluate the plurality of parameters to determine one or more scores, and generate an adoption maturity score for the technology ecosystem. The adoption maturity score provides a quantifiable assessment of an innovation's readiness within a technology ecosystem, measuring its optimization, efficiency, and level of innovation.

These techniques result in a practical application that effectively solves the limitations of conventional assessment methods by providing a data-driven, automated, and scalable evaluation process. By identifying specific signals in need of optimization, the system enables organizations to implement targeted software or hardware updates that will directly enhance their adoption maturity score. This predictive capability allows organizations to proactively improve their technology stack, reducing inefficiencies, optimizing resource allocation, and ensuring long-term sustainability. This also provides clear, data-backed insights into where improvements should be made, and implement appropriate and optimal software or hardware updates that will enhance the adoption maturity score.

Another significant improvement is the optimization of network usage. Traditional adoption maturity assessments often require extensive data transfers, as organizations manually collect and consolidate technical documentation, architecture diagrams, security reports, and other records from disparate sources. This process not only creates a significant network burden but also introduces inefficiencies due to redundant or unnecessary data retrieval. In contrast, the disclosed system optimizes network usage by leveraging targeted data extraction and on-demand processing. Rather than transferring entire repositories or large-scale datasets, the system intelligently queries and retrieves only the relevant portions of data necessary for evaluating adoption maturity signals. Additionally, by processing data locally or within distributed computing environments before transmitting results, the system significantly reduces the overall network load (e.g., through different preprocessing steps).

Furthermore, the system introduces improvements in data processing and storage efficiency by leveraging intelligent data classification techniques. By selectively analyzing relevant datasets, including a technical documentation data set, WAF data set, and enterprise-specific data set, the system minimizes computational overhead while maximizing the accuracy of the adoption maturity assessment. This efficient processing ensures that the system remains scalable and adaptable, even when applied across large enterprises with complex technology ecosystems. Through these improvements, the disclosed system provides a robust and scalable solution for evaluating and managing adoption maturity, empowering organizations to maintain a competitive edge in an increasingly technology-driven world.

### Exemplary Computing Environment

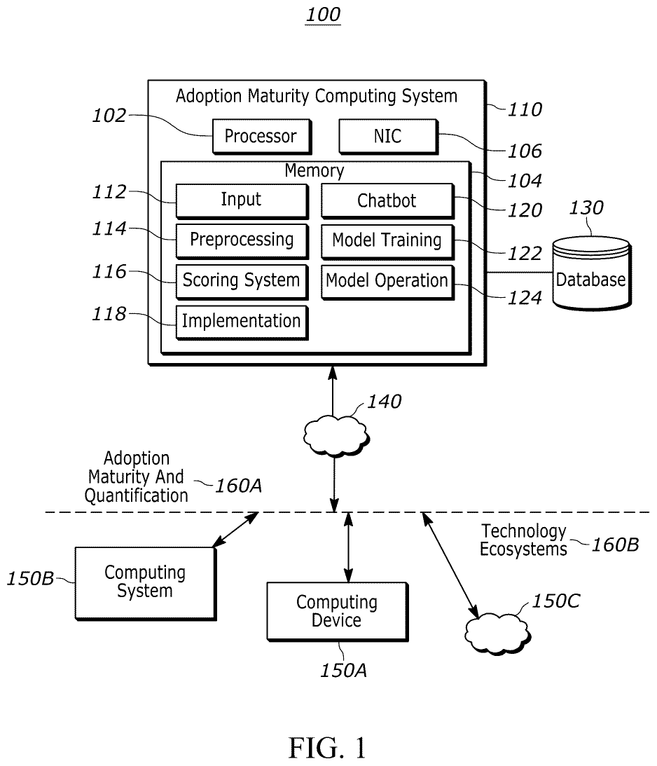

FIG. 1 depicts a computing environment 100 comprising an adoption maturity computing system 110 for evaluating and managing adoption maturity within one or more technology ecosystems 160B by analyzing one or more input data sets comprising a technical documentation data set, a well-architected framework (WAF) data set, enterprise specific data set, technical debt data set, and/or requirements data set. The computing system 110 includes a processor 102, a memory 104, and a network interface controller (NIC) 106. The memory 104 may comprise input 112, preprocessing 114, scoring system 116, implementation 118, chatbot 120, model training 122, and model operation 124.

The processor 102 may include any number of processors and/or processor types, such as central processing units (CPUs), graphics processing units (GPUs), and others. Generally, the processor is configured to execute software instructions stored in the memory 104. The memory 104 may include volatile and/or non-volatile fixed and/or removable memory, such as read-only memory (ROM), random access memory (RAM), and others. The memory has stored thereon one or more sets of computer-executable instructions.

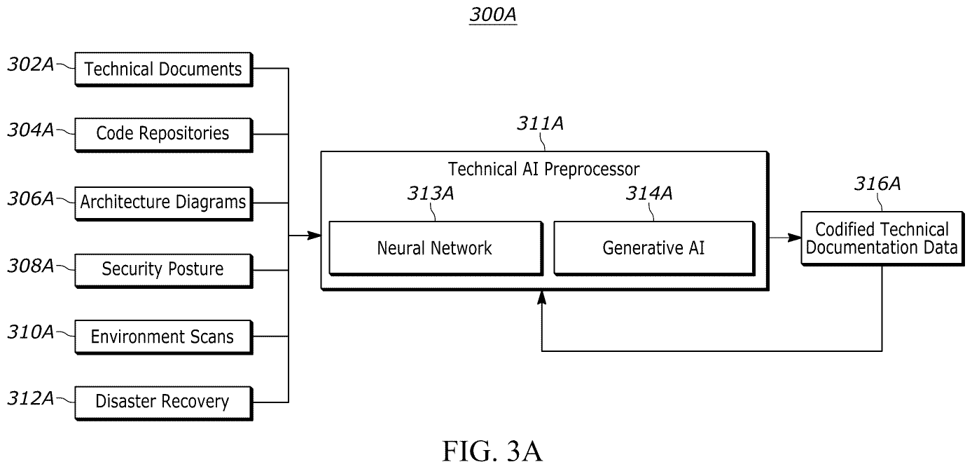

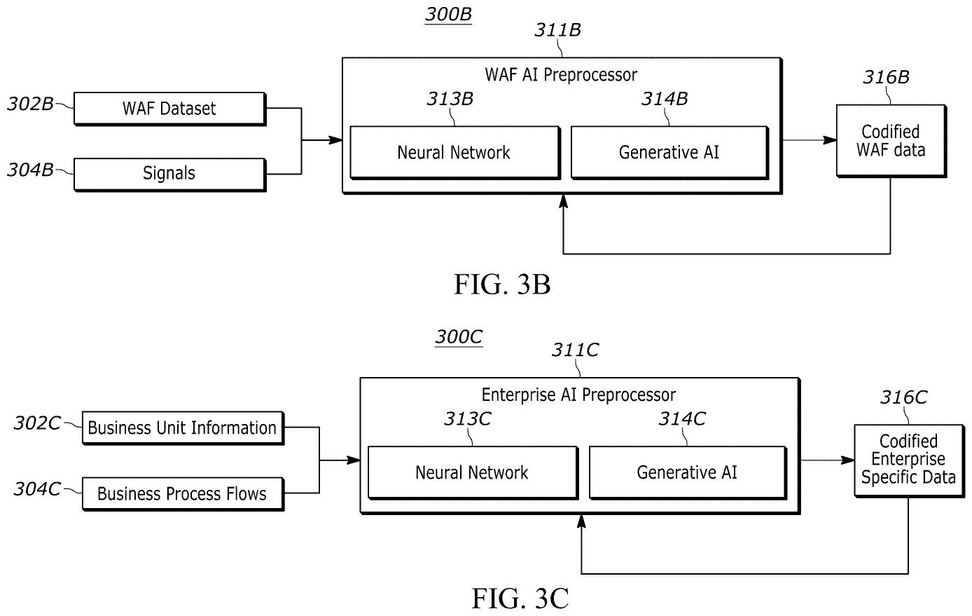

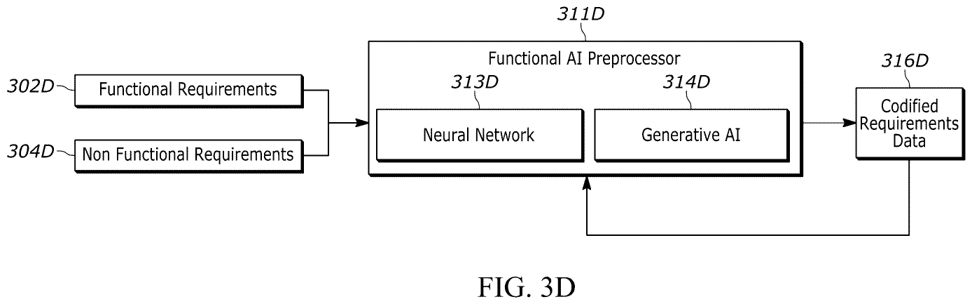

The memory 104 may include instructions for implementing a plurality of modules, each module comprising a respective set of processor-executable instructions for performing various sets of functions. An input module 112 may obtain input data from multiple sources, including a technical documentation data set (e.g., technical documents, code repositories, architecture diagrams, security posture, environment scans, disaster recovery), a WAF data set (e.g., signals, established WAF regulations from cloud providers), enterprise specific data set (e.g., business unit information and business process flows), technical debt data set, and requirements data set (e.g., functional requirements and non-functional requirements). The input module 112 may also analyze application architecture diagrams and process flows of the technical documentation data set against well-architected framework data set and the requirement data set when collected the one or more input data sets. In some embodiments, users of the computing device 150A may provide the input data to the adoption maturity computing system 110 through the network 140. The exemplary input data are further described in relation to FIGS. 3A-3D.

A preprocessing module 114 may utilize neural networks, generative artificial intelligence models, reinforcement learning with human feedback, and/or other models or data processing techniques, to analyze or preprocess the input data 112 to obtain preprocessed data (i.e., a plurality of parameters) associated with the input data 112. The preprocessed data may be structured or codified datasets that are classified and optimized for downstream analysis and conversion by other system modules. The preprocessing module 114 may comprise a plurality of preprocessor modules, each preprocessor module designed to train and output different types of codified dataset. For example, the preprocessing module 114 may convert the technical documentation input data set (e.g., technical documents, code repositories, architecture diagrams, security posture, environment scans, disaster recovery) into a codified technical documentation using a technical AI preprocessor module. Details and exemplary embodiments of preprocessing are further discussed below in relation to FIGS. 3A-3D.

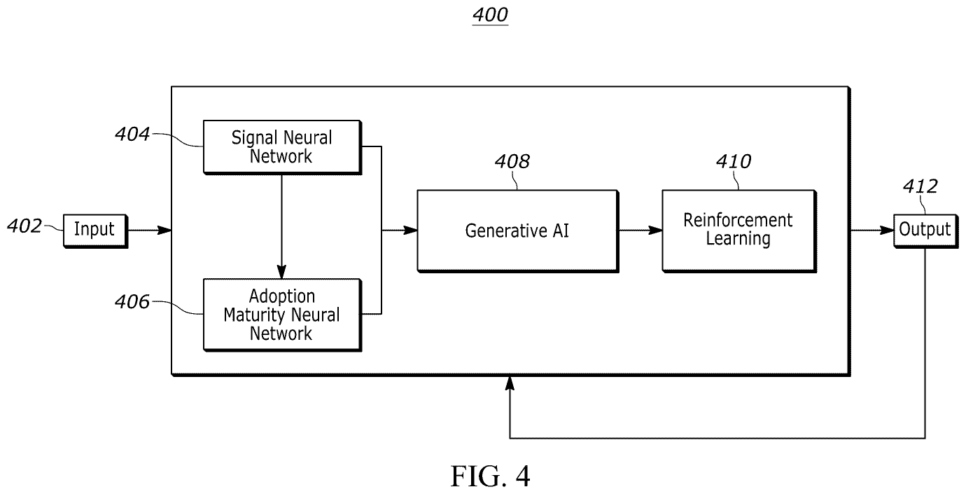

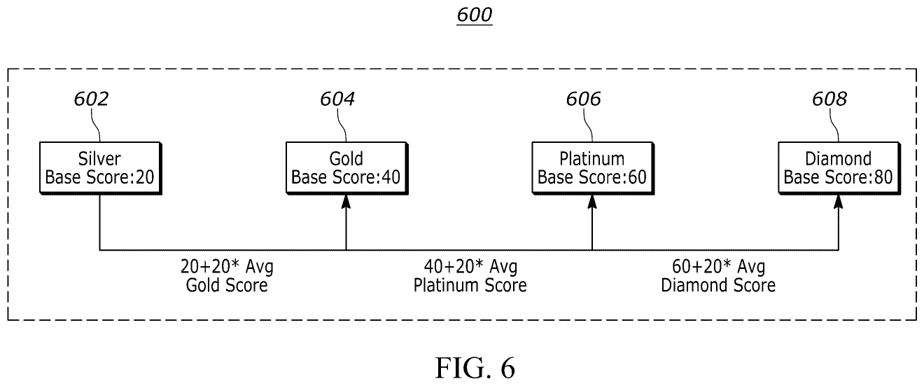

A scoring system module 116 may utilize neural networks, generative artificial intelligence models, reinforcement learning with human feedback, and/or other data processing techniques to evaluate the plurality of parameters to determine or predict one or more scores for one or more criteria (i.e., signal scores) of the technology ecosystem. The scoring system module 116 may then generate an adoption maturity score for the technology ecosystem based on the one or more scores for the one or more criteria of the technology ecosystem. The scoring system module 116 may account for variations across different business units when determining signal scores and the overall adoption maturity score. For example, an IT business unit may have a more stringent threshold for evaluating its technology ecosystem compared to other business units, resulting in distinct adoption maturity scores for different organizational segments. Additionally, the scoring system module 116 may identify specific signals or criteria that require improvement based on the predicted signal scores. For instance, if a cloud architecture signal receives a score of 0, it may indicate that the cloud infrastructure is not fully optimized and could enhance its adoption maturity by implementing an updated cloud architecture. By pinpointing areas for improvement, the system enables targeted enhancements that can incrementally increase the overall adoption maturity score. Furthermore, the scoring system module 116 may categorize the adoption maturity score into predefined levels, such as Silver, Gold, Platinum, and Diamond, to provide a structured and interpretable representation of the technology ecosystem's maturity. The methodology and categorization details of the scoring system module 116 are further illustrated in FIGS. 4 and 6.

An implementation module 118 may identify one or more software or hardware updates to the technology ecosystem based on the one or more scores for the one or more criteria that would increase the adoption maturity scores. For example, the system may identify criteria that received low scores (e.g., 0) for the one or more software or hardware updates to improve those criteria. The implementation module 118 may generate appropriate hardware or software updates designed to increase the signal scores and recommend one or more updates that the technology ecosystem can implement to enhance its overall maturity. The implementation module 118 may take into account the preprocessed data and various organizational factors, such as budget constraints, business priorities, and industry-specific requirements, when recommending updates. In some embodiments, the implementation module 118 may identify and suggest the most recent or optimal software or hardware updates based on real-time industry standards and best practices. The implementation module 118 may further automate the implementation of these updates where applicable.

In certain embodiments, the implementation module 118 may leverage an AI model to generate personalized recommendations for hardware or software updates. Alternatively, the module may rely on a predefined list of approved updates, where a signal that lacks the approved update from the list is assigned a low score. In such cases, the implementation module 118 may recommend the required update from the predefined list.

A chatbot module 120 may include a chatbot configured to respond to user queries regarding the adoption maturity of the technology ecosystem. The chatbot module 120 may utilize a generative artificial intelligence model to generate contextually relevant responses based on real-time adoption maturity assessments (e.g., signal scores, adoption maturity score, etc.). To generate responses, the chatbot module 120 may leverage various data inputs, including the adoption maturity score, input data 122, the plurality of preprocessed data, adoption maturity signals, and their respective signal scores. By integrating these data sources, the chatbot module 120 provides users with detailed insights into the technology ecosystem's maturity level, areas requiring improvement, and potential actions for optimization. This interactive system enhances user accessibility by offering real-time feedback and recommendations tailored to an organization's specific adoption maturity landscape.

A model training module 122 may be responsible for developing and refining the artificial intelligence models used in the assessment of adoption maturity. This module utilizes historical data, technology adoption patterns, and prior adoption maturity assessments to train machine learning algorithms. The goal is to improve the accuracy and efficiency of adoption maturity scoring by enabling the system to learn from past evaluations and adapt to evolving technology landscapes. The model training module 122 may train artificial intelligence models for preprocessing collected data, generating signal scores, and computing the adoption maturity score.

The model training module 122 may utilize training data comprising a labeled dataset of input data and corresponding preprocessed data to train preprocessing AI models. These AI models may include a neural network model configured to classify the input dataset into different categories. For example, in the case of a Well-Architected Framework (WAF) dataset, the neural network model may categorize the input data into different WAF pillars, such as operational excellence, security, reliability, performance efficiency, and cost optimization. Once classified, the preprocessing AI models may include a generative AI (Gen AI) model to synthesize and refine the categorized information, thereby generating the preprocessed data used for further assessment.

The model training module 122 may also train scoring models using labeled preprocessed data to predict scores for various signals, compute the adoption maturity score, and/or generate a report of that summarizes the different scores. The training data may include historical adoption maturity assessments, predefined scoring benchmarks (e.g., signal scores and/or adoption maturity scores), and a structured summary of adoption maturity scores. The scoring models may comprise neural network models that analyze different signals within the technology ecosystem and predict their respective scores, as well as the overall adoption maturity score. Additionally, a generative AI model may be utilized to extract, summarize, and interpret the signal scores and the adoption maturity score, providing structured insights that aid in decision-making and optimization strategies.

The model training module 122 may incorporate human feedback. For example, the model training module 122 may use reinforcement learning with human feedback (RLHF), which allows the models to adjust and improve over time based on expert evaluations of their outputs. This feedback loop ensures that the models remain relevant and accurate as the organization's technology landscape and priorities evolve. In some aspects, the training process is not a one-time event but an ongoing cycle of improvement, in which as the models are used and generate outputs, the results are reviewed by experts who provide feedback. This feedback may then used by the model training module 122 to further refine the models, adjust the weighted scores of coding signals, and improve the accuracy of adoption maturity score quantification and reporting. Therefore, the model training module 122 may integrate human feedback for continuous learning and adjustment of an adoption maturity assessment process. In some embodiments, the model training module 122 may automate the feedback loop and train the model based on its own feedback or output. For instance, when the scoring system module 116 outputs signal scores and/or an adoption maturity score, these scores may input back to the scoring system module 116 to train its AI models.

In some embodiments, the model training module 122 may automate the feedback loop by continuously refining the AI models using their own outputs. For instance, when the scoring system module 116 generates signal scores and/or an adoption maturity score, these scores may be fed back into the system as training data to enhance the accuracy and adaptability of the AI models. This iterative learning process enables the system to identify patterns, adjust weighting factors, and improve its predictive capabilities over time, ensuring that future assessments better reflect the evolving state of the technology ecosystem.

To support the development, training, and operation of the adoption maturity assessment models, the model training module 122 may employ a suite of machine learning and data science technologies. Open-source libraries such as TensorFlow, PyTorch, Scikit-learn, and Pandas in Python may be used for constructing and managing neural networks, statistical modeling, and data manipulation. To efficiently process large volumes of enterprise data, the system may leverage big data frameworks such as Apache Spark or Hadoop. In cloud-based implementations, AI and machine learning platforms such as Google AI Platform, Azure Machine Learning, or AWS SageMaker may be utilized for scalable model training and deployment.

The model training module 122 may also train one or more language models (LMs) to facilitate adoption maturity assessments. In some implementations, the model training module 122 may pre-train or fine-tune a language model locally or through cloud-based APIs, such as OpenAI's GPT (Generative Pre-trained Transformer). Language models can assist in extracting insights from technical documentation, generating structured reports on adoption maturity, and interpreting complex technology environments. These capabilities enhance productivity by automating the generation of recommendations, summarizing adoption trends, and facilitating knowledge transfer across different business units. The integration of LMs within the system provides an advanced framework for efficiently evaluating and managing adoption maturity in a technology ecosystem.

A model operation module 124 applies the trained AI models in real-time or near-real-time environments to assess the current adoption maturity of a technology ecosystem. This module processes newly collected data from the technology environment, including technical documentation, architecture diagrams, and enterprise-specific datasets, to determine the present state of adoption maturity. The model operation module 124 ensures that adoption maturity evaluations are dynamic, relevant, and actionable by continuously integrating new data. It may utilize trained AI models for preprocessing datasets, predicting signal scores, and computing the adoption maturity score to provide real-time assessments and recommendations for improvement.

The NIC 106 may include any suitable network interface controller(s), such as wired/wireless controllers (e.g., Ethernet controllers), and facilitate bidirectional/multiplexed networking over the network between the computing system 110 and other components or systems. The network may be a single communication network or may include multiple communication networks of one or more types (e.g., one or more wired and/or wireless local area networks (LANs), and/or one or more wired and/or wireless wide area networks (WANs) such as the Internet).

The network 140 may connect a computing system 110 and facilitate its interaction with external data sources and users. The network 140 may include both physical and virtual components that together enable the transmission of data across the computing environment 100. The physical components of the electronic network 140 may include one or more servers that store and process data, routers and switches that direct data traffic, and cabling and/or wireless technology infrastructure that links these devices. The virtual components may include software such as network operating systems, network management tools, and communication protocols that ensure data is transmitted securely and arrives at its intended destination within the computing environment 100. The computing system 110 may access the network 140 to collect data from a wide range of sources, including internal systems, databases, and online resources.

The network 140 enables user interaction with system 110 through various interfaces, such as web portals or applications, allowing them to input data, configure settings, and view outputs like reports, dashboards, and interactive chatbots via one or more APIs (not depicted). The network 140 ensures that interactions between users and the system are smooth and responsive, enhancing the user experience.

The system 110 may be communicatively coupled to, and/or include within its memory 104, an electronic database 130. The electronic database 130 may be designed to store, manage, and provide access to the data collected and generated by the system 110. The database 130 may store structured data, such as process information, technology infrastructure details, governance policies, and various data points associated with the technology ecosystem, as well as unstructured data, including industry reports, news articles, and technical documentation. Additionally, the electronic database 130 may store training data used by the model training module 122, and other various types of information to manage and evaluate adoption maturity score including input data 112, signal scores, adoption maturity signals, adoption maturity scores, and other datasets relevant to the assessment of the technology ecosystem. The electronic database 130 may be optimized for rapid data retrieval and real-time analysis, enabling the system 110 to efficiently access both historical and current data for evaluating adoption maturity, identifying areas for improvement, and supporting proactive decision-making. The design, structure, and implementation of the electronic database 130 may be aligned with the requirements of the adoption maturity assessment system to ensure scalability, accuracy, and responsiveness.

For example, to implement the electronic database 130 within the computing environment 100, one or more database technologies may be utilized, such as a relational database management system (RDBMS) (e.g., MySQL, PostgreSQL, or Oracle Database); a NoSQL databases (e.g., MongoDB, Cassandra, or Couchbase) a graph database, an in-memory database, a time-series database, a cloud-based database, etc.

The computing environment 100 of FIG. 1 may be logically divided according to an adoption maturity assessment environment 160A, and one or more technology ecosystems 160B. The adoption maturity assessment environment 160A may include the system 110 and its components. For example, the adoption maturity assessment ecosystems 140A may include one or more components that are evaluated for adoption maturity levels. The one or more tech ecosystems 140B may include one or more ecosystem computing device 150A, one or more ecosystem computing services 150B, and/or one or more ecosystem computing networks 150C. Of course, depending upon the environment in which the system 110 is deployed, the one or more tech ecosystems 140B may include more or fewer (or different) components 150. For example, the components 150 may include various interconnected components that work together, such as operating systems, applications, and development tools that enable devices to perform tasks and provide functionality to users; network infrastructure including local area networks (LAN), wide area networks (WAN), the internet, and wireless networks; data that is processed, stored, and transmitted by the computing ecosystem, including databases, data warehouses, and big data platforms; security components such as encryption software/devices, firewalls, and antivirus software; cloud/remote servers and services that provide scalable computing resources, storage, and applications over the internet; middleware such as APIs and message brokers/queues; user interfaces including graphical user interfaces (GUIs), command-line interfaces (CLIs), and voice interfaces; hardware and solutions for saving data, such as hard drives, solid-state drives (SSDs), network-attached storage (NAS), and cloud storage; integration services; support/maintenance services including technical support, software updates, and hardware maintenance; and standards and protocols. Any of the foregoing devices, services, networks, etc. may contribute to adoption maturity, and may be modified to improve the adoption maturity using the present techniques.

One or more components of the computing environment 100 of FIG. 1 may be implemented as cloud-based services. For example, the electronic database 130 may be hosted on a cloud platform such as Amazon Web Services (AWS), Google Cloud Platform (GCP), or Microsoft Azure, leveraging scalable storage solutions and managed database services like Amazon RDS or Google Cloud SQL. This cloud-based implementation allows for dynamic scaling to accommodate varying loads and data volumes, ensuring that the system can efficiently handle the extensive data analysis required for evaluating and managing adoption maturity. Additionally, merely for example, the model training module 122 and the model operation module 124 may utilize cloud-based machine learning and AI services, such as AWS SageMaker or Google AI Platform, to train and deploy sophisticated models for evaluating and managing. This cloud-based approach provides the flexibility and computational power needed to process large datasets and apply complex algorithms, enhancing the system's ability to deliver real-time insights and recommendations. It should be appreciated that the computing environment 100 could utilize a public cloud, such as AWS, GCP, or Azure, to leverage their infrastructure and services for scalability and flexibility. Alternatively, a private cloud may be employed, offering more control over the environment and potentially enhanced security for sensitive data related to adoption maturity. A hybrid cloud approach may also be adopted, combining the benefits of both public and private clouds by keeping certain critical operations and data on-premises or in a private cloud for security and compliance reasons, while utilizing the public cloud for scalable computing resources and advanced services. This hybrid model allows for a balanced approach, optimizing the system's performance and security based on the specific needs of evaluating and managing adoption maturity.

In operation, the adoption maturity computing system 110 serves as a system for evaluating and managing adoption maturity within a technology ecosystem. The adoption maturity computing system 110 may collect one or more input data sets from a technology ecosystem (e.g., input data 112), which comprises various sources of information about the technology ecosystem, including a technical documentation dataset, a Well-Architected Framework (WAF) dataset, an enterprise-specific dataset, a technical debt dataset, and/or a requirements dataset. The adoption maturity computing system 110 may preprocess and analyze the one or more input datasets to obtain a plurality of parameters (i.e., preprocessed data) associated with the one or more input data sets. The preprocessed data may be structured or codified representations of the input data, making them more suitable for evaluation by the scoring system 116. For example, input datasets may include unstructured records such as compliance reports, software versioning logs, or network security assessments. The adoption maturity computing system 110 may analyze to obtain a plurality of parameters such as operating system type, cloud service provider, software version numbers, encryption protocol details, or infrastructure redundancy levels. The scoring system 116 may then evaluate the preprocessed data to determine one or more scores for one or more criteria (i.e., signals) of the technology ecosystem. The signals may be data points, metrics, or indicators that provide insights into the state, behavior, or performance of the technology ecosystem. A single parameter within the plurality of parameters may be analyzed independently as a criterion and assigned a corresponding signal score, whereas a group of related parameters may be collectively evaluated to form a single criterion, resulting in a unified signal score. For example, CPU utilization efficiency may be assessed as an individual criterion, where a lower utilization percentage under peak load conditions may result in a lower score, while an optimally balanced utilization percentage may receive a higher score. In contrast, system security resilience may be evaluated as a collective criterion by analyzing multiple parameters, such as encryption strength, authentication mechanism robustness, firewall rule compliance, and intrusion detection responsiveness, which together determine a single signal score representing the overall security posture of the technology ecosystem.

The adoption maturity computing system 110 may then generate an adoption maturity score for the technology ecosystem based on the one or more scores for the one or more criteria of the technology ecosystem. For example, the scoring system 116 may aggregate the signal scores to generate an overall adoption maturity score. The adoption maturity score may indicate the extent to which the technology ecosystem is optimized. The system 110 may categorize the adoption maturity score into predefined levels, such as Silver, Gold, Platinum, or Diamond, providing a structured framework for assessing the ecosystem's maturity.

To facilitate continuous improvement, the adoption maturity computing system 110 may utilize an implementation module 118 to identify signals with low scores and recommend specific software or hardware updates that could optimize these signals and therefore increase the adoption maturity score. By implementing these recommendations, organizations can increase signal scores, thereby improving the overall adoption maturity of their technology ecosystem. In some embodiments, the computing system 110 may automatically implement the one or more software or hardware updates. Additionally, the adoption maturity computing system 110 may integrate a chatbot module 120 to serve as an interactive platform where users can submit queries regarding adoption maturity. The chatbot module 120 may be powered by a generative artificial intelligence model trained on various datasets, including input data, signals, signal scores, adoption maturity scores, and recommended hardware or software updates. This allows the chatbot 120 to provide accurate, context-aware responses to user inquiries, assisting organizations in understanding their adoption maturity status and identifying actionable steps for improvement.

The preprocessing module 114 and the scoring system module 116 may utilize various artificial intelligence models to preprocess input data 112 and predict signal scores and the adoption maturity score. The preprocessing module 114 may employ neural network models, generative AI models, and other machine learning techniques to classify, normalize, and structure raw input data into preprocessed data (i.e., plurality of parameters). These datasets enable the scoring system module 116 to efficiently analyze relevant parameters and compute adoption maturity assessments. The scoring system module 116 may apply neural network models, generative AI models, and other machine learning techniques to predict different signal scores, assess overall adoption maturity, and generate a structured report summarizing the scores. By leveraging AI-driven scoring methodologies, the system can accurately determine the maturity level of individual signals and provide actionable insights (e.g., software or hardware updates) into areas requiring improvement, and implement the software or hardware updates. The adoption maturity computing system 110 may utilize the model training module 122 to develop and refine the AI models used in preprocessing, signal scoring, and adoption maturity score predictions. The model operation module 124 may execute the trained AI models in real-time or near-real-time environments to process newly received data, predict signal scores, and compute an overall adoption maturity score.

Further operation of the computing system 110 is included in the following description of motivating use cases. It should be appreciated that other use cases are contemplated.

### Exemplary Use Cases

In one example for the use case of Legacy System Modernization, each module within the adoption maturity computing system 110 plays a role in identifying, quantifying, and prioritizing the modernization of a legacy system that is costly to maintain and hinders organizational agility. The input module 112 initiates the process by collecting comprehensive data about the organization, including a technical documentation dataset that details the system's architecture. The input module 112 lays the groundwork for understanding the scope and scale of adoption maturity by providing a detailed overview of the legacy system's current state, including the software and hardware platforms, tools, and processes in use. Following this, the preprocessing module 114 processes the collected datasets, which may include a technical documentation dataset, technical debt dataset, requirements dataset, WAF dataset, and enterprise-specific dataset. The preprocessing module 114 codifies and structures these datasets, ensuring they are in a format that allows for efficient analysis by the scoring system module 116. Additionally, preprocessing may involve analyzing the complexity of the codebase, evaluating adherence to coding standards, and extracting relevant parameters that influence modernization decisions. Once the input data 112 has been preprocessed, the scoring system module 116 evaluates the preprocessed data (i.e., parameters) to generate signal scores and an adoption maturity score. The scoring system module 116 assesses different aspects of the technology ecosystem, integrating both technical and business inputs to produce the adoption maturity score. The quantification of the signal scores and the adoption maturity score by the scoring system module 116 may highlight critical areas that require modernization and provides a measurable metric to help organizations prioritize remediation efforts. During the scoring process, the scoring system module 116 may also account for differences across business units that have varying modernization thresholds. For example, an IT business unit may require a more advanced security software threshold compared to a marketing business unit, which may have lower threshold for security software. The system adjusts its scoring methodology accordingly to ensure that modernization recommendations align with the specific requirements of each business unit. After predicting the signal scores and adoption maturity score, the implementation module 118 identifies specific signals that require modernization. Based on the signal scores, the implementation module 118 may recommend software or hardware updates to modernize the signals and improve the legacy system's infrastructure. For instance, if the system is operating on an outdated cloud platform and receives a low cloud infrastructure signal score, the implementation module 118 may recommend upgrading to a modern cloud architecture to enhance scalability, security, and efficiency. In some embodiments, the implementation module 118 may also automatically apply software or hardware updates. For example, the implementation module 118 may automatically update the cloud infrastructure to improve system performance and security. This adoption maturity scoring process enables the system to continuously assess its efficiency and optimization, ensuring that necessary software or hardware updates are applied to legacy systems and appropriate signals requiring modernization.

In another example for the use case of Security Vulnerability Identification, the computing system 110 helps detect, assess, and mitigate security risks. The input module 112 collects security-related data, including a technical documentation dataset that details the system's security posture, which may include vulnerability reports, system logs, network activity data, compliance records, and security policies. This dataset provides an overview of the system's security state, identifying potential risks. The preprocessing module 114 structures and normalizes this data, classifying vulnerabilities by severity, filtering redundant alerts, and correlating security events with system configurations. This enables the scoring system module 116 to efficiently analyze security signals and predict risk levels. The scoring system module 116 then evaluates the system's security risks, generating signal scores and an overall security adoption maturity score based on factors such as known vulnerabilities, compliance adherence, and the effectiveness of existing security controls. The scoring system module 116 may also account for different security requirements across business units. For example, an IT infrastructure team may require stricter encryption and intrusion detection compared to a marketing department. Once the signal scores are determined, the implementation module 118 may identify specific signals that require upgrades and recommend hardware and software updates, such as applying patches, updating firewall settings, or adjusting access controls. In some cases, the implementation module 118 may automate security updates for critical vulnerabilities, such as enforcing encryption upgrades or restricting access to high-risk components. This ensures organizations can proactively strengthen their security posture, reduce risks, and maintain compliance with industry standards.

In yet another example for the use case of Optimizing Development Processes, the computing system 110 enhances development efficiency by identifying and addressing areas where low adoption maturity hinders productivity. The input module 112 collects development-related data, including a technical documentation dataset that details the development environment, coding practices, deployment workflows, version control records, and automation frameworks. This dataset provides insights into the current state of development processes and highlights inefficiencies. The preprocessing module 114 structures and normalizes this data, classifying it by key factors such as coding standards adherence, deployment frequency, test automation coverage, and collaboration efficiency. This enables the scoring system module 116 to efficiently analyze development signals and predict their impact on adoption maturity. The scoring system module 116 then generates signal scores and an overall adoption maturity score based on factors such as process automation, code maintainability, and integration efficiency. The scoring system module 116 may also account for different requirements across teams. For example, a backend development team may require higher code coverage and CI/CD automation compared to a frontend development team focused on UI enhancements. Once the signal scores are determined, the implementation module 118 may identify specific signals that require optimizations and recommend hardware or software updates for optimizations, such as introducing automated testing, improving documentation, or refining deployment workflows. In some cases, the implementation module 118 may automate process optimizations, such as enforcing code quality standards or triggering automated testing pipelines. This ensures that organizations can streamline development workflows, reduce inefficiencies, and enhance overall software delivery performance, thereby increasing the adoption maturity score.

In another example for the use case of Strategic Decision Making for Business Recovery Preparedness, the computing system 110 ensures that an organization is adequately prepared for disaster recovery (DR) by assessing and addressing adoption maturity gaps that could impede recovery efforts. The input module 112 collects disaster recovery-related data, including a technical documentation dataset comprising DR plans, backup configurations, failover strategies, incident response procedures, and infrastructure resilience reports. Additionally, the input module 112 may gather an enterprise-specific dataset that includes business process flows, operational dependencies, and critical system priorities to align technical recovery strategies with business continuity objectives. The preprocessing module 114 structures and normalizes this data, classifying it by key factors such as system redundancy, recovery point objectives (RPO), recovery time objectives (RTO), business impact analysis, and compliance with DR best practices. This structured dataset enables the scoring system module 116 to analyze DR-related signals and predict their impact on adoption maturity. The scoring system module 116 then generates signal scores and an overall adoption maturity score based on the preprocessed data. The scoring system module 116 may also account for different recovery requirements across business units. For example, a financial services division handling real-time transactions may require near-instant failover capabilities, while a document management team may have more flexible recovery timelines. Once the signal scores are determined, the implementation module 118 may identify specific signals that require upgrades and recommend hardware or software updates, such as enhancing backup frequency, automating failover processes, or revising business continuity policies. In some cases, the implementation module 118 may automate recovery optimizations, such as enforcing scheduled disaster recovery drills, triggering backup verifications, or integrating AI-driven anomaly detection to proactively identify system vulnerabilities. This ensures that organizations can strengthen their disaster recovery readiness, minimize downtime, and maintain business continuity even in the face of unforeseen disruptions, thereby improving the adoption maturity score.

### Exemplary Computer-Implemented Methods

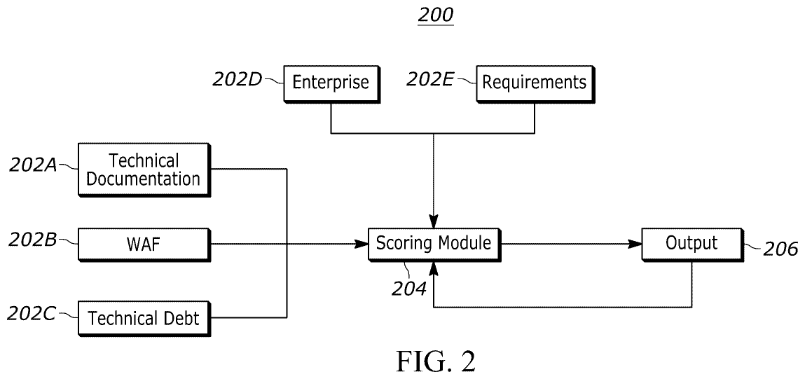

FIG. 2 depicts a computer-implemented method 200 for evaluating and managing adoption maturity within a technology ecosystem, according to some embodiments. The method 200 may include processing input data sets comprising technical documentation data set (block 202A), well-architected framework (WAF) data set (block 202B), technical debt data set (block 202C), enterprise specific data set (block 202D), and requirements data set (block 202E).

The method 200 may obtain a plurality of preprocessed data(i.e., parameters) from blocks 202A, 202B, 202C, 202D, and 202E. A scoring module (block 204) may predict or generate signal scores and an adoption maturity score of the technology ecosystem. The signals may be data points, metrics, or indicators that provide insights into the state, behavior, or performance of the technology ecosystem. For example, signals may include CPU utilization efficiency within cloud infrastructure, which measures the percentage of allocated computing resources actively used. Low signal scores may indicate inefficiencies, outdated infrastructure, security vulnerabilities, or other weaknesses that hinder the adoption maturity of the technology ecosystem. In contrast, high signal scores may indicate that a specific aspect of the system is well-optimized, aligned with best practices, and operating efficiently. The adoption maturity score may represent an extent to which the technology ecosystem is optimized, providing an overall assessment of the system's technological readiness. The method 200 may include generating an output 206. The output 206 may comprise information regarding the adoption maturity including the adoption maturity score and signal scores. Details and examples of each block in the FIG. 2 are further described below and, for various blocks, in relation to FIGS. 3A-6.

FIG. 3A depicts a block flow diagram of an example computer-implemented method 202A for codifying technical documentation data set associated with an existing technology ecosystem, according to some embodiments. Codifying technical documentation may involve structuring and optimizing the dataset to improve accessibility and analysis by the scoring module 204. The technical documentation may be a collection of materials that describe the design, functionality, configuration, and operation of the technology ecosystem. The method 300A generally corresponds to block 202A of the method 200 of FIG. 2. The method 300A may process technical documentation inputs and generate reports using artificial intelligence. The method 300A may include receiving technical documentation data set including technical documents (block 302A), code repositories (block 304A), architecture diagrams (block 306A), security posture 308A, environment scans 310A, and disaster recovery 312A. Although not explicitly shown in FIG. 3A, the dataset may also include additional information such as compliance reports, configuration files, operational logs, etc.

Technical documents (block 302A) may include manuals, specifications, white papers, and guidelines that describe the system's functionality, design, dependencies, and integration with other components, supporting the adoption maturity assessment. Code repositories (block 304A) may include source code files, version control history, build scripts, and documentation related to software development and maintenance, offering insights into coding practices, modularity, reusability, and adherence to best practices such as continuous integration and deployment (CI/CD). Architecture diagrams (block 306A) may consist of system architecture blueprints, network topology diagrams, data flow diagrams, and infrastructure schematics, illustrating component interactions and aiding in the evaluation of scalability, system dependencies, and architectural efficiency. Security posture (block 308A) may encompass vulnerability assessments, penetration test reports, compliance audits, access control policies, encryption protocols, and security logs, helping assess security robustness and identify risks that could impact the adoption maturity score. Environment scans (block 310A) may include assessments of the system's deployment environment, such as cloud infrastructure reports, resource utilization metrics, system health monitoring logs, and performance benchmarks, contributing to evaluations of operational efficiency, reliability, and resource optimization. Disaster recovery (block 312A) may cover business continuity plans, backup and recovery policies, failover strategies, recovery point objectives (RPO), and recovery time objectives (RTO), ensuring the system is prepared for failures and can recover efficiently, enhancing overall resilience and adoption maturity.

A technical AI preprocessor module (block 311A) may comprise a neural network (block 313A) and a generative AI (block 313A). The neural network may receive the technical documentation inputs from blocks 302A, 304A, 306A, 308A, 310A, and 312A and in response classify the technical documentation inputs by applications (e.g., categories) (block 313A). For example, classifying by application may involve grouping technical documentation based on software type (e.g., backend services, frontend applications, APIs, or database management systems), deployment environment (e.g., cloud-based, on-premises, or hybrid infrastructure), or functionality (e.g., security monitoring, data processing, user authentication, or networking). By categorizing technical documentation based on these criteria, the system can efficiently analyze how different components interact, streamline adoption maturity assessments, and tailor recommendations for modernization or optimization.

Following the classification, the method 300A may include generating one or more reports by the generative AI model (block 314A), resulting in codified or preprocessed technical information (block 316A), or a technical documentation parameter. The generative AI model synthesizes the classified technical documentation inputs into structured, standardized formats suitable for downstream processing. For example, after categorizing technical documentation based on deployment environment, the generative AI model may extract and structure relevant details to generate a system configuration summary. This summary may include identified dependencies, infrastructure components, compatibility constraints, and compliance requirements based on architecture diagrams, configuration files, and security policies. In some embodiments, based on the codified technical information 316A, the technical AI preprocessor module (block 311A) may perform a reinforcement learning to improve the neural network 312A and the generative AI model 314A. In some embodiments, the generative AI model may also provide a summarized technology landscape based on the classified technical documentation inputs.

FIG. 3B depicts a block flow diagram of an example computer-implemented method 300B for codifying a well-architected framework (WAF) dataset associated with an existing technology ecosystem, according to some embodiments. Codifying the WAF dataset may involve structuring and optimizing the dataset to improve accessibility and analysis by the scoring module 204. The WAF dataset may include structured guidelines, best practices, and assessment criteria that help evaluate the operational efficiency, security, reliability, performance, and cost-effectiveness of a system. The method 300B generally corresponds to block 202B of the method 200 in FIG. 2. The method 300B may process WAF datasets and generate structured reports using artificial intelligence. The method 300B may include receiving a WAF dataset (block 302B), which may comprise WAF guidelines provided by different software providers (e.g., cloud providers), along with various signals (block 304B) corresponding to key architectural principles.

The WAF dataset (block 302B) may include well-architected framework (WAF) guidelines provided by various software providers, such as cloud service providers and enterprise architecture frameworks. While different providers may define their own WAF implementations, they generally align with key architectural principles that establish best practices for designing and maintaining scalable, secure, and efficient systems. The WAF dataset may be structured around different categories (i.e., pillars), which may represent fundamental aspects of system architecture. Within each pillar, signals (block 304B) may serve as specific metrics or indicators that assess adherence to best practices and highlight areas for improvement. The pillar may include, but not limited to, operational excellence, security, reliability, performance efficiency, cost optimization, and sustainability. The operational excellence may focus on supporting development and operational workflows efficiently through automation, monitoring, and continuous improvement, with signals such as system observability score, deployment frequency, incident response time, and change failure rate. The security may ensure the protection of systems and data through risk management, access controls, and compliance with security policies, with signals including encryption strength, firewall rule compliance, multi-factor authentication adoption, and vulnerability scan results. The reliability may evaluate a system's ability to recover from failures and maintain business continuity, measured through signals such as system uptime percentage, failover success rate, backup frequency, and recovery time objectives (RTO). The performance efficiency may assess the effective use of computing resources to maintain system responsiveness and scalability, with signals including resource utilization rate, query execution time, auto-scaling efficiency, and network latency. The cost optimization may focus on managing resources cost-effectively while maintaining performance, using signals such as cloud instance right-sizing ratio, reserved vs. on-demand resource usage, cost per transaction, and auto-scaling cost efficiency. The sustainability may address environmental impact by optimizing resource usage and reducing energy consumption, evaluated through signals such as carbon footprint reduction, energy efficiency rating, and data center power utilization effectiveness (PUE).

A WAF AI preprocessor module (block 311B) may include a neural network (block 313B) and a generative AI model (block 314B) to process and structure WAF data set. The neural network may receive WAF datasets from blocks 302B and 304B and classify them into categories. For example, classifying by category may involve grouping different signals under corresponding WAF categories, such as operational excellence, security, reliability, performance efficiency, cost optimization, and sustainability. By organizing the WAF dataset according to these predefined categories, the system can efficiently analyze architectural best practices, assess adoption maturity, and generate insights tailored to specific areas of optimization. This structured classification improves downstream processing, enabling more accurate scoring and targeted recommendations for improving system architecture.

Following the classification, the method 300B may include generating one or more reports by the generative AI model (block 314B), resulting in codified or preprocessed WAF data (block 316B), or a WAF data parameter. The generative AI model may synthesize the classified resource profile inputs into structured, standardized formats suitable for downstream processing. For example, if the classification is based on performance efficiency, the generative AI model may generate a resource utilization analysis, detailing query execution time, auto-scaling efficiency, and network latency. In some embodiments, based on the codified WAF information 316B, the resource profile AI preprocessor module 311B may perform reinforcement learning to improve the neural network 313B and the generative AI model 314B.

The technical debt data set (block 202C), or technical debt assessment, may comprise a detailed evaluation of the current state of the technology ecosystem, identifying areas where technical debt exists and quantifying its impact on performance, security, and maintainability. Technical debt may refer to the accumulated cost of suboptimal design decisions, outdated technologies, or deferred maintenance that hinders a system's functionality, scalability, or compliance. This assessment may involve analyzing legacy codebases, identifying deprecated frameworks or libraries, reviewing system configurations for inefficiencies, and pinpointing architectural flaws. In some embodiments, the adoption maturity computing system 110 may use a neural network to classify the technical debt data by applications (e.g., categories) and generate one or more reports by using a generative AI model, resulting in codified or preprocessed technical debt information (or technical debt parameter).

An exemplary method to determine a technical debt assessment is detailed in U.S. patent application Ser. No. 18/889,583, entitled “ANALYSIS AND CLASSIFICATION METHODS AND SYSTEMS FOR ASSESSING, IDENTIFYING, AND TRACKING TECHNICAL DEBT IN ORGANIZATIONS,” which was filed on Sep. 19, 2024, and is incorporated herein by reference in its entirety. The technical debt assessments may assess technical debt within a technology ecosystem (e.g., of an organization) and identify areas for technical debt improvement. The technical debt assessments may include actionable strategies based on the assessment of technical debt, such as a detailed report of technical debts by applications, a report of technical debts by business functions, an interactive chatbot for stakeholder engagement, and a dashboard for visualizing technical debt data and progress in addressing identified debts, etc.

FIG. 3C depicts a block flow diagram of an example computer-implemented method 300C for codifying enterprise specific dataset, according to some embodiments. The enterprise specific dataset may comprise information regarding the organization, providing insights into its operational structure, workflows, and strategic alignment. The method 300C generally corresponds to block 202D of the method 200 of FIG. 2. The method 300C may process the enterprise specific dataset and generate reports using artificial intelligence. The method 300C may include receiving the enterprise specific dataset associated with the existing technology ecosystem including business unit information (block 302C) and business process flows (block 304C).

Business unit information (block 302C) may include organizational hierarchies, department structures, roles and responsibilities, interdepartmental dependencies, and strategic priorities. This data helps in assessing how different business units interact with technological infrastructure and how adoption maturity varies across the enterprise. Business process flows (block 304C) may comprise standardized workflows, operational procedures, automation processes, approval hierarchies, and dependencies between business operations and IT systems. By analyzing these process flows, the system can identify inefficiencies, optimize automation strategies, and align technological improvements with business objectives.

Different business units may comprise different technical thresholds for adoption maturity based on their operational needs, regulatory requirements, and business objectives. For example, an IT or cybersecurity department may require higher security and compliance standards, including stricter access controls, encryption protocols, and continuous vulnerability assessments, whereas a marketing department may prioritize performance efficiency and automation capabilities to streamline campaign management and customer engagement. Similarly, a finance department may emphasize reliability and data integrity, requiring robust backup strategies and audit compliance, while a product development team may focus on operational excellence, ensuring agile workflows, continuous integration, and scalable cloud infrastructure. By recognizing these varying thresholds, the system can tailor adoption maturity assessments and recommendations to align with each business unit's unique requirements, optimizing resource allocation and strategic planning.

An enterprise AI preprocessor module (block 311C) may comprise a neural network (block 313C) and a generative AI (block 314C). The neural network may receive the enterprise specific inputs from blocks 302C and 304C, and in response classify the enterprise specific inputs by the business units. Following the classification, the method 300C may include generating one or more reports by the generative AI model (block 314C), resulting in codified or preprocessed enterprise specific data (block 316C), or an enterprise specific data. The generative AI model may synthesize the classified enterprise specific data set into structured, standardized formats suitable for downstream processing. For example, the generative AI model may generate a business unit technology alignment report that details how each department's technological infrastructure supports its operational needs. In some embodiments, based on the codified enterprise specific dataset 316C, the data conversion AI preprocessor module (block 311C) may perform reinforcement learning to improve the neural network 313C and the generative AI model 314C.

FIG. 3D depicts a block flow diagram of an example computer-implemented method 300D for codifying a requirements data set, according to some embodiments. The requirements data set may be different organizational requirements in the technology ecosystem including functional and non-functional requirements. Method 300D generally corresponds to block 202E of the method 200 of FIG. 2. The method 300D may process requirements data set and generate reports using artificial intelligence. The method 300D may include receiving requirements data sets including functional requirements (block 302D) and non-functional requirements (block 304D).

Functional requirements (block 302D) may define the specific capabilities and behaviors that the technology ecosystem must support, such as business logic, user interactions, data processing, and system workflows. These requirements may include API specifications, authentication mechanisms, transaction processing rules, and reporting functionalities. Non-functional requirements (block 304D) may describe the system's performance, security, scalability, compliance, and maintainability standards. These requirements may include latency thresholds, encryption standards, regulatory compliance mandates, fault tolerance mechanisms, and disaster recovery objectives. By codifying both functional and non-functional requirements, the system ensures that adoption maturity assessments align with the organization's operational needs, industry regulations, and best practices.

A functional AI preprocessor module 311D may comprise a neural network (block 313D) and a generative AI model (block 314D). The neural network may receive the requirements dataset from blocks 302D and 304D, and in response classify the requirements dataset by applications (block 313D). For example, classifying by application may involve grouping functional and non-functional requirements according to relevant technology domains, such as enterprise resource planning (ERP), cybersecurity protocols, cloud infrastructure management, or customer relationship management (CRM). Following the classification, the method 300D may include generating one or more reports by the generative AI model (block 314D), resulting in codified or preprocessed requirements dataset (block 316D), or a requirements parameter. The generative AI model may synthesize the classified requirements dataset into structured, standardized formats suitable for downstream processing. For example, the generative AI model may generate a capability assessment report, which details business logic, user interaction, data processing, and system workflow requirements. In some embodiments, based on the codified requirements dataset 316D, the software correction AI preprocessor module 311D may perform reinforcement learning to improve the neural network 313D and the generative AI model 314D.

FIG. 4 depicts a block flow diagram of a scoring module according to some embodiments. The method 400 generally corresponds to the scoring module 204 of the method 200 of FIG. 2. FIG. 4 may include input 402 comprising the preprocessed data (block 402), score predictions (block 404 and 406), summarization (block 408), and reinforcement learning (block 410).

The signal neural network 404 may utilize preprocessed data (i.e., a plurality of parameters), including the preprocessed technical documentation dataset, preprocessed WAF dataset, preprocessed enterprise-specific dataset, preprocessed technical debt dataset, and/or preprocessed requirements dataset, to determine one or more scores for one or more criteria (i.e., signals) of the technology ecosystem. The signals may be data points, metrics, or indicators that provide insights into the state, behavior, or performance of the technology ecosystem. Each signal may represent a key attribute of the technology ecosystem, such as cloud infrastructure, security posture, automation efficiency, or compliance adherence. A signal may be derived from a single parameter within the plurality of parameters or a group of related parameters that collectively define a particular criterion. For example, a cloud infrastructure-related signal may be based on a single parameter such as auto-scaling responsiveness, while a security compliance signal may be determined by evaluating multiple parameters, including firewall rule enforcement, authentication mechanism strength, and encryption standards.

The signal neural network 404 may analyze these signals and assigns a numerical score for each signal that reflects the adoption maturity by analyzing different factors including scalability, security, efficiency, etc. A low signal score may indicate inefficiencies, outdated infrastructure, security vulnerabilities, or poor optimization, whereas a high signal score may suggest adherence to best practices and strong adoption maturity. For example, if one or more cloud infrastructure-related signals, such as compute resource utilization efficiency, storage redundancy, network latency, or auto-scaling responsiveness, receive a score of 0, it may indicate that the technology ecosystem lacks auto-scaling capabilities, has an outdated cloud architecture, or fails to meet cost optimization benchmarks. In response, the adoption maturity computing system can optimize the technology ecosystem by implementing hardware and/or software improvements such as cloud workload balancing, resource auto-scaling, and updated security protocols, enhancing overall adoption maturity.

The adoption maturity neural network 406 may use the signal scores and/or preprocessed data to determine an overall adoption maturity score, which represents the extent to which the technology ecosystem is optimized. A low adoption maturity score may indicate inefficiencies, outdated technology, or gaps in best practices, suggesting that the system could improve by implementing software updates, infrastructure upgrades, or enhanced automation strategies. Conversely, a high adoption maturity score may indicate that the technology ecosystem may be well-optimized, secure, and aligned with industry standards. The adoption maturity neural network 406 may generate an adoption maturity score for the technology ecosystem based on the signals scores (i.e., one or more scores for the one or more criteria of the technology ecosystem). For example, the adoption maturity score may be a sum of all the signal scores determined by the signal neural network 404. In some embodiments, the adoption maturity neural network 406 may use different approaches to compute the adoption maturity score. In one embodiment, it may rely solely on preprocessed data to generate the score, evaluating trends, patterns, and technological indicators without predefined scoring classifications. For example, it may analyze data from architecture diagrams, compliance reports, and operational workflows to infer the technology ecosystem's adoption maturity level. In another embodiment, the adoption maturity neural network 406 may utilize a defined scoring classification system, allowing it to assign adoption maturity levels based on the signal scores. Details regarding this scoring classification system are further illustrated in FIG. 6.

In some embodiments, the adoption maturity neural network 406 may determine the adoption maturity score based on different business units within the enterprise. The adoption maturity neural network 406 may generate a local adoption maturity score by evaluating the scores of one or more criteria (i.e., signals) within the technology ecosystem for parameters associated with a specific business unit. Since adoption maturity thresholds can vary across business units, the system may apply the local business adoption maturity threshold when determining the local adoption maturity score. For instance, an IT security department may have stricter security and compliance requirements than a marketing team, necessitating a higher threshold for encryption protocols, intrusion detection, and access control measures. Such adoption maturity thresholds for specific business units may be defined in the business unit information 302C of the enterprise-specific dataset. The adoption maturity neural network 406 may also generate an enterprise adoption maturity score based on one or more scores for the one or more criteria of the technology ecosystem for parameters associated with the enterprise, which reflects the overall adoption maturity of the entire organization. Unlike local maturity scores tailored to specific business units, the enterprise adoption maturity score is based on a general enterprise maturity threshold, encompassing broader organizational standards and best practices. This score provides a holistic view of the organization's technological adoption across all business units. To determine the final overall adoption maturity score, the adoption maturity neural network 406 may consider both the enterprise adoption maturity score and the local adoption maturity scores. Depending on the influence of a specific business unit within the enterprise, the system may assign different weights to these scores. For example, in a cybersecurity-focused enterprise, a software business unit may play a critical role in determining the organization's overall technology maturity. In such a case, the local adoption maturity score for the software business unit may carry a higher weight in the final adoption maturity score compared to other business units. As a numerical illustration, the final adoption maturity score may be 80% of enterprise adoption maturity score+20% of local adoption maturity score.

Upon generating the adoption maturity score and one or more signal scores, an implementation module (not illustrated in FIG. 4) may identify signals with low scores that, if improved, could enhance the adoption maturity of the technology ecosystem through hardware and software updates. The implementation module may determine appropriate hardware and software updates based on the plurality of preprocessed data and/or the corresponding signal scores, ensuring that recommendations align with the specific needs and constraints of the technology ecosystem. The implementation module may determine that the technology ecosystem may need hardware and software updates based on low signal scores. For example, if one or more network infrastructure-related signals, such as bandwidth utilization efficiency, packet loss rate, latency stability, or redundancy of failover mechanisms, receive a low score, the implementation module may implement software or hardware updates such as deploying advanced traffic shaping algorithms, upgrading network switches or routers, optimizing load balancing configurations, or enhancing failover redundancy protocols to optimize the technology ecosystem.

The implementation module may also apply different hardware and/or software updates based on the preprocessed data such as enterprise specific data (e.g., specifical business needs), technical documentation dataset (e.g., different architecture diagrams), etc. For instance, even if both a marketing organization and a cybersecurity organization have low signal scores for cloud infrastructure, the recommended updates may differ based on their distinct operational requirements. The marketing organization may benefit from updates that enhance collaborative cloud tools or customer data analytics, whereas the cybersecurity organization may require enhanced cloud encryption, automated intrusion detection, or stricter access control mechanisms. By customizing updates based on signal scores and preprocessed data, the implementation module ensures that optimizations effectively enhance the technology ecosystem's adoption maturity while aligning with organizational priorities.

The implementation module may be a machine learning model that processes preprocessed data, adoption maturity scores, and/or signal scores to identify areas within the technology ecosystem that require software or hardware updates, recommend software or hardware updates, and implement the software or hardware updates. The implementation module may identify inefficiencies in the technology ecosystem based on the low signal scores and recommend appropriate updates based on the preprocessed data, including specific business needs, existing technology architecture, and operational constraints. By considering these contextual factors, the implementation module ensures that the recommended updates align with the organization's infrastructure and strategic goals.

In some embodiments, the implementation module may autonomously implement the identified software or hardware updates, streamlining the optimization process. In other embodiments, the implementation module may rely on a predefined list of software and hardware updates mapped to specific signals. For example, if one or more cloud-based signals, such as compute resource utilization efficiency, auto-scaling responsiveness, or storage redundancy, receive low scores and are included in the predefined list, the implementation module may automatically recommend and/or apply hardware or software updates specified in the predefined list. This could involve upgrading the cloud database to a more scalable storage solution, enhancing disaster recovery mechanisms, or optimizing workload distribution to improve overall system performance.

The summarization model 408 may extract and synthesize key information related to adoption maturity based on the plurality of preprocessed data, signal scores, and/or the adoption maturity score and generate an output 412. The summarization model 408 may generate the output 412 that includes an explanation of how individual signal scores were determined, the methodology used to compute the adoption maturity score, and specific hardware or software updates recommended for improving the technology ecosystem. The summarization model 408 may utilize a generative AI model to analyze and structure this information into a concise, human-readable format.

The scoring module may utilize reinforcement learning with human feedback (RLHF) (block 410) to iteratively refine and improve the signal neural network, adoption maturity neural network, and generative AI model. By incorporating expert evaluations, user corrections, and real-world outcomes, the system can enhance the accuracy and reliability of its predictions. For instance, human reviewers may assess signal scores assigned by the signal neural network and provide feedback if certain scores do not align with expected system performance. This feedback allows the model to adjust its weightings, refine its learning parameters, and improve future predictions. Similarly, the adoption maturity neural network may leverage RLHF to fine-tune the relationships between signal scores and the overall adoption maturity score, ensuring that its assessments align with domain-specific best practices and organizational benchmarks. The generative AI model may also benefit from reinforcement learning by incorporating feedback on the clarity, accuracy, and relevance of its generated summaries and recommendations. Over time, the iterative feedback loop enables the scoring module to become more precise in assessing adoption maturity, identifying critical areas for improvement, and generating actionable insights tailored to the organization's evolving needs.

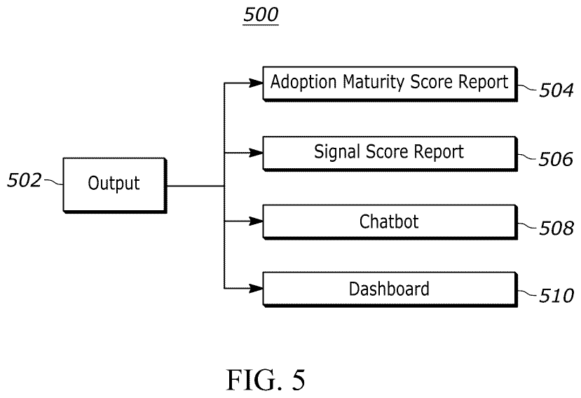

FIG. 5 illustrates a block flow diagram of how the output 502 may be displayed. The output 502 may include information generated by the scoring module in FIG. 4 and may correspond to output 412 of FIG. 4. The system may present output 502 in multiple formats, including an adoption maturity score report 504, a signal score report 506, an interactive chatbot 508, and a dashboard 510. In some embodiments, the adoption maturity score report 504 and the signal score report 506 may be combined into a single comprehensive report that summarizes the adoption maturity of the technology ecosystem.

The adoption maturity score report 504 may provide a detailed analysis of how the adoption maturity score was calculated. This may include a breakdown of the factors considered in scoring, different signal scores of the technology ecosystem, and an explanation of how different technical ecosystem parameters contribute to the overall maturity assessment. The report may also classify the adoption maturity score into predefined tiers (e.g., silver, gold, platinum, or diamond). Details to the classification may be further illustrated in FIG. 6. Additionally, the report may outline recommendations for improving the adoption maturity score, such as implementing specific hardware or software updates.

The signal score report 506 may provide a detailed assessment of each signal contributing to the adoption maturity score, offering a comprehensive breakdown of the specific metrics or indicators that reflect different aspects of the technology ecosystem. For each signal, the report may include a signal description, explaining the particular technical ecosystem attribute being evaluated within a broader category, such as compute resource utilization within cloud infrastructure, firewall rule compliance within security posture, or deployment frequency within automation efficiency. It may also present a signal score, numerically representing how well the signal aligns with best practices and industry standards. Additionally, the report may provide an analysis and justification for the assigned score, detailing key influencing factors such as resource allocation efficiency, security vulnerabilities, system downtime, or bottlenecks in automation workflows. To support continuous improvement, the report may offer targeted recommendations for optimization, suggesting hardware or software updates. For example, if a compute resource utilization signal within cloud infrastructure receives a low score, the report may recommend optimizing virtual machine allocation, enabling auto-scaling mechanisms, or migrating workloads to a more cost-efficient cloud provider to enhance system efficiency and overall adoption maturity.

The chatbot 508 may function as an interactive assistant powered by a generative artificial intelligence model, capable of responding to user queries regarding adoption maturity. The chatbot may dynamically retrieve relevant information from adoption maturity scores, input datasets, a plurality of parameters (preprocessed data), one or more criteria (i.e., signals), and/or signal scores to generate informative responses. For example, if a user asks, “Why is my security score low?”, the chatbot may analyze security-related signals, identify vulnerabilities, and suggest potential improvements such as enforcing stricter access control policies, applying software patches, or improving encryption standards. The chatbot may also provide historical comparisons, showing how the score has changed over time and what measures have previously been taken to improve it.

The dashboard 510 may serve as a centralized visualization platform, providing users with real-time monitoring of adoption maturity insights and facilitating data-driven decision-making. It may feature interactive data visualizations that display adoption maturity trends over time, allowing users to track improvements and identify areas that require attention. Comparative analysis tools may enable users to assess signal scores across different business units, applications, or infrastructure components, helping organizations pinpoint inconsistencies or gaps in technology adoption. The dashboard may also offer filtering and customization options, allowing users to focus on specific signals, time periods, or organizational departments to tailor the analysis to their needs. Additionally, it may provide live monitoring of system health, tracking the impact of recent optimizations on adoption maturity scores and highlighting potential risks. The dashboard may also include automated alerts that notify users when certain signals fall below a predefined threshold, prompting proactive interventions to maintain adoption maturity.

FIG. 6 illustrates different adoption maturity score categories for a technology ecosystem. When the scoring system determines an adoption maturity score, it assigns the score to a specific category based on predefined thresholds. As depicted in FIG. 6, the categories may include a silver category (block 602), a gold category (block 604), a platinum category (block 606), and a diamond category (block 608). A technology ecosystem may initially be assigned to the silver category, representing the lowest level of adoption maturity, and may progressively improve its score through targeted optimizations. One way to enhance the adoption maturity score is by improving specific signals within the technology ecosystem, as discussed above. The ecosystem may progress to a higher category one stage at a time, based on achieving the required signal scores associated with the next category's threshold.

The scoring system may rely on a predefined list of signals to evaluate the technology ecosystem and generate its adoption maturity score. Each signal in this list may be assigned a score of either zero (0), one (1), or not available (NA). Signals marked as not available indicate that a specific metric is not applicable to the technology ecosystem and will be excluded from the final score calculation. The average signal score is then computed (which would have a value between 0 and 1), and a weighting factor (e.g., 20) is applied to determine the final adoption maturity score.

As the adoption maturity score progresses through higher categories, each subsequent category has a stricter threshold for qualification. For instance, the requirements to move from silver to gold may be less demanding than progressing from platinum to diamond, which requires stricter compliance with best practices and higher levels of optimization.

As an illustrative example in FIG. 6, the technology ecosystem may first be assigned to the silver category, which represents the lowest maturity level. To advance from silver to gold, the scoring system applies the gold threshold to the predefined signals and calculates an average signal score. This score is then multiplied by a weighting factor (e.g., 20) and added to the silver baseline score (e.g., 20). If the resulting total adoption maturity score meets or exceeds the gold base score (e.g., 40), the technology ecosystem may upgrade to the gold category.

At a later time, the scoring system may evaluate whether the ecosystem qualifies for the platinum category by applying a platinum threshold, which imposes stricter requirements than the gold category. For example, under the gold threshold, a cloud system might only require basic redundancy and security compliance, whereas the platinum threshold may demand advanced fault tolerance, automation, and enhanced security controls. The average score is again multiplied by the weighting factor (e.g., 20) and added to the gold baseline score (e.g., 40). If the total adoption maturity score meets or exceeds the platinum base score (e.g., 60), the ecosystem advances to the platinum category.

The technology ecosystem may also be downgraded if the scoring system determines that it no longer meets the minimum requirements for its current category (not illustrated in FIG. 6). For example, if an ecosystem is currently in the gold category but its signal scores deteriorate, failing to meet the gold threshold when applied to the silver baseline score (e.g., 20), and resulting in a total score below the gold base score (e.g., 40), the system may reassign the ecosystem to the silver category. This dynamic reassessment ensures that the adoption maturity classification remains an accurate reflection of the ecosystem's current state and encourages continuous optimization.

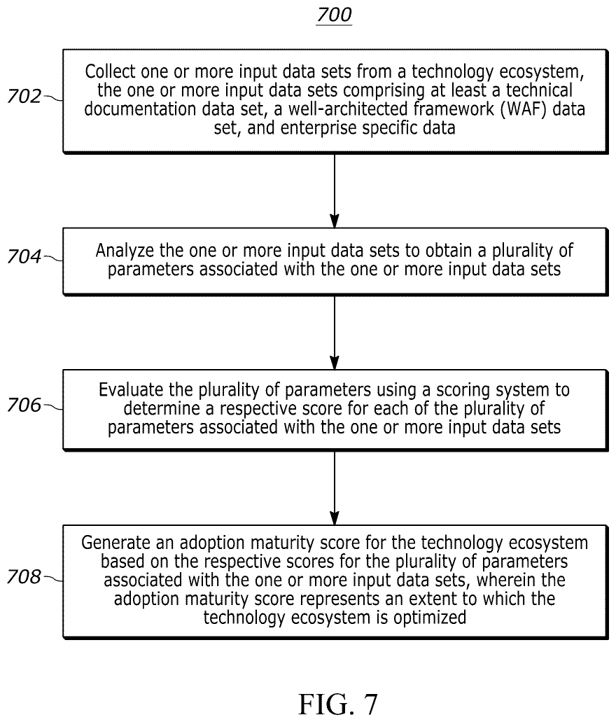

FIG. 7 illustrates an example method 700 for evaluating and managing adoption maturity within a technology ecosystem. The method can be implemented in a set of instructions stored on a computer-readable memory and/or executable at one or more processors of an adoption maturity computing system 110.

At block 702, the adoption maturity computing system may collect one or more input data sets from a technology ecosystem, the one or more input data sets comprising at least a technical documentation data set, a well-architected framework (WAF) data set, and an enterprise specific data set. In some embodiments, the one or more input data sets may further comprise a technical debt dataset or a requirements dataset. In some other embodiments, collecting the one or more input data sets may further comprise analyzing application architecture diagrams and process flows of the technical documentation data set against the well-architected framework data set and the requirements data set. The technical documentation dataset may comprise one or more of: technical documents, code repositories, architecture diagrams, security postures, environment scans, or disaster recovery files.

At block 704, the adoption maturity computing system may analyze the one or more input data sets to obtain a plurality of parameters associated with the one or more input data sets. In some embodiments, analyzing the one or more input data sets may further include the adoption maturity computing system to preprocess the one or more input data sets by applying the one or more input data sets to a trained machine learning model to classify information from the one or more input data sets into the plurality of parameters.

At block 706, the adoption maturity computing system may evaluate the plurality of parameters using a scoring system to determine one or more scores for one or more criteria of the technology ecosystem based on the plurality of parameters. In some embodiments, evaluating the one or more criteria to determine the one or more scores further include analysis of scalability, security, and other factors defining the adoption maturity score.

At block 708, the adoption maturity computing system may generate an adoption maturity score for the technology ecosystem based on the one or more scores for the one or more criteria of the technology ecosystem. The adoption maturity score may represent an extent to which the technology ecosystem is optimized. In some embodiments, the adoption maturity computing system may generate a local adoption maturity score based on the one or more scores for the one or more criteria of the technology ecosystem for parameters associated with a particular business unit, and generate an enterprise adoption maturity score based on the one or more scores for the one or more criteria of the technology ecosystem for parameters associated with the enterprise. The adoption maturity computing system may then generate the adoption maturity score by combining the enterprise adoption maturity score and the local adoption maturity score. In some other embodiments, generating the adoption maturity score includes the adoption maturity computing system to apply, for each of the one or more criteria, the criterion to a first machine learning model to generate a respective score for the criterion, The adoption maturity score may then apply the respective scores for the one or more criteria to a second machine learning model to generate the adoption maturity score.

In some embodiments, the adoption maturity computing system may identify one or more software or hardware updates to the technology ecosystem based on the one or more scores for the one or more criteria for the one or more criteria that would increase the adoption maturity score. The adoption maturity computing system may then implement the one or more software or hardware updates in the technology ecosystem. In some other embodiments, the adoption computing system may integrate human feedback for continuous learning and adjustment of an adoption maturity assessment process.

In some embodiments, the adoption maturity score may be a category selected from at least one of: a silver category, a gold category, a platinum category, or a diamond category. The technology ecosystem may be initially assigned the silver category. The adoption maturity computing system may then generate the adoption maturity score such that the technology ecosystem progresses to a higher category one stage at a time based on the one or more scores for the one or more criteria associated with the higher category.

In some embodiments, the adoption maturity computing system may apply one or more of: the adoption maturity score, the one or more input data sets, the plurality of parameters, the one or more criteria, or the one or more scores for the one or more criteria to a generative artificial intelligence model configured to generate responses to user queries regarding the adoption maturity. The adoption maturity computing system may then provide a response to a user query regarding the adoption maturity via a chatbot.

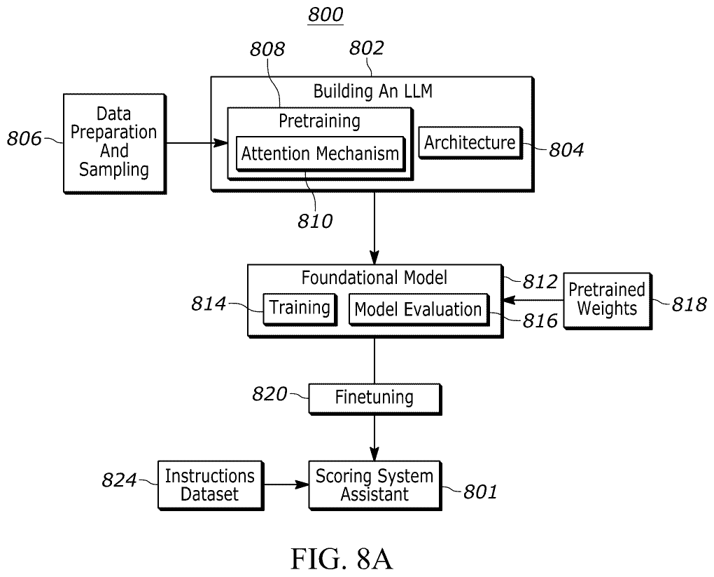

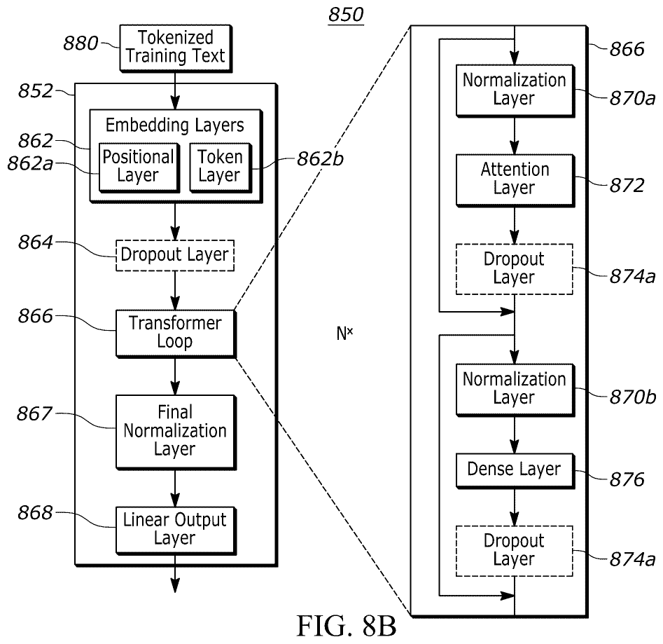

FIG. 8A depicts a block-flow diagram outlining a method 800 for building and applying an artificial intelligence model, specifically a language learning model (LLM), according to some aspects. The method 800 may include the creation and/or utilization of an LLM to develop a scoring system assistant. The method 800 begins with data preparation and sampling, which includes processing data pertinent to a given application of the LLM (block 806). Subsequently, the method 800 involves the construction of an LLM (block 804) which encompasses pretraining with an attention mechanism (block 808), as well as the formulation of the model's architecture (block 810). The pretraining phase is undertaken to establish a foundational model (block 812) that learns from the prepared data, suited to the LLM's intended use. Within the foundational model (block 812), additional steps of training (block 814) and model evaluation (block 816) are performed. During this phase, the model may also benefit from pretrained weights (block 818), which can accelerate the training by drawing on previously acquired patterns and knowledge.

After the foundational model is established, the process includes finetuning (block 820), which is the calibration and optimization stage, utilizing more focused data pertaining to the specific application of the LLM. This phase is crucial for honing the LLM to produce accurate outcomes within its intended operational domain. Finally, an instructions dataset (block 824) is provided to the scoring system assistant (block 801). This dataset could contain structured instructions and prompts that facilitate the LLM in generating relevant analyses and responses. These prompts promote the practical implementation of the trained model, enabling it to function effectively as part of the scoring system assistant. FIG. 8A illustrates a structured approach for developing a specialized LLM aimed at a certain application, starting with data preparation and sampling, progressing through model construction with pretraining and architecture development, and culminating in the finetuning and deployment of a scoring system assistant that operates in conjunction with a dedicated instructions dataset. This visual aid encapsulates the sequence of steps necessary to forge a tool that supports the specific application for which the LLM is designed, according to some aspects.

The language learning model (LLM) outlined in method 800 directly supports the functions of the model training module 122 and the model operation module 124 within the computing environment. The LLM's initial steps of data preparation and sampling (block 806) align with the data collection and preparation activities of the model training module 122 to develop AI models that can accurately evaluate and manage adoption maturity. This module utilizes a variety of data sources, including code repositories, applications, and architecture diagrams to train neural network models and generative AI models.

The construction phase of the LLM, including pretraining with an attention mechanism (block 808) and the formulation of the model's architecture (block 810), parallels the development process within the model training module 122. This process involves using machine learning and data science libraries to build models capable of understanding and predicting adoption maturity patterns.

The foundational model (block 812) of the LLM, which undergoes additional training (block 814) and evaluation (block 816), reflects the iterative training and refinement process of AI models within the model training module 122. This module may leverage historical data and coding practices to enhance the accuracy and efficiency of the adoption maturity scoring process.

The finetuning stage (block 820) of the LLM is crucial for optimizing the model's performance for its specific application, mirroring the continuous improvement efforts of the model training module 122 to ensure the models remain relevant and accurate as the organization's technology landscape evolves.

Finally, the instructions dataset (block 824) provided to the scoring system assistant (block 801) enables the practical application of the LLM within the computing environment. This functionality is akin to the role of the model operation module 124, which applies trained AI models to new data to assess current adoption maturity and recommend actions for its improvement or management.

FIG. 8B illustrates a neural network-based model architecture for processing and analyzing data related to adoption maturity (block 852). The process begins with data collection (block 880) which is then passed through preprocessing layers, specifically a data normalization layer (block 862a) and a feature extraction layer (block 862b). These layers are followed by a dropout layer (block 864) to prevent overfitting. The core of the architecture is the neural network loop (block 866), which is iterated N times, where N is a positive integer. Each iteration consists of a normalization layer (block 870a), followed by an attention layer (block 872) with its own dropout layer (block 874a), another normalization layer (block 870b), a dense layer (block 876), and another dropout layer (block 874b). The process concludes with a final normalization layer (block 867) and a linear output layer (block 868), producing the final output from the neural network-based model. This architecture is designed to handle and analyze data for identifying and managing adoption maturity.

The model architecture depicted in FIG. 8B may be used to analyze and evaluate adoption maturity, particularly in the context of identifying inefficiencies, compliance gaps, and opportunities for modernization. This neural network-based architecture facilitates the processing of diverse data through a series of layers and loops designed to understand and identify patterns related to adoption maturity effectively. Initially, the collected data is processed through preprocessing layers, including normalization and feature extraction layers, which help the model understand the significance of each data point within the context of adoption maturity. This is crucial for effectively managing adoption maturity as it allows the system to grasp the nuances of the organization's technical environment, including outdated technologies, compliance issues, and potential areas for improvement. The dropout layers introduced after the preprocessing layers and within the neural network loop serve to prevent overfitting by randomly omitting some of the units from the layers during training. This ensures that the model does not become too reliant on the training data, allowing it to generalize better to new, unseen data. The neural network loop, iterated N times, is where the bulk of the analysis happens. Each iteration consists of a series of layers including normalization, attention, and dense layers, each followed by dropout layers. The normalization layers help stabilize the learning process, while the attention layers allow the model to focus on different parts of the input data to better understand the relationships between various factors contributing to adoption maturity. The dense layers, on the other hand, are fully connected layers that help in learning non-linear combinations of the features. The final normalization layer ensures that the data is normalized before passing it to the linear output layer, which produces the final output of the model.

Individuals can engage with the model to quantify and score of adoption maturity, leveraging the capabilities of a computing environment equipped with artificial intelligence, including language learning models (LLMs). These activities encompass collecting and analyzing data from diverse sources within a technology ecosystem, such as code repositories, application architecture diagrams, and process flows. By determining coding signals from coding practices, including code complexity and coding standards adherence, individuals can identify signals that can improve the adoption maturity. Interacting with an LLM, such as the LLM of FIG. 8A and FIG. 8B, individuals can refine the process of adoption maturity assessment by generating code, providing documentation, and summarizing technical documents, thereby enhancing productivity and code quality. For example, an LLM can be used to automate the generation of code snippets that adhere to best practices, reducing the likelihood of introducing low adoption maturity. Additionally, LLMs can interpret complex datasets and summarize technical documents, providing insights that inform the adoption maturity assessment process. The scoring system module 116 within the computing environment evaluates various aspects of technology and business inputs to produce a composite score or assessment of adoption maturity. This scoring process is supported by machine learning models, including neural networks and generative AI models, which are trained using structured and unstructured data from the organization's technology environment. The model training module plays a crucial role in developing and refining these AI models, using historical data, coding practices, and outcomes from previous assessments to improve the accuracy and efficiency of the adoption maturity scoring process. Furthermore, the model operation module applies the trained AI models to new data, enabling the system to assess current adoption maturity, predict future states, and recommend actions for increasing adoption maturity. This proactive management of adoption maturity is facilitated by the system's ability to integrate human feedback, ensuring continuous learning and adjustment of the assessment process.

### Exemplary Aspects

The various embodiments described above can be combined to provide further embodiments. All U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

Aspects of the techniques described in the present disclosure may include any of the following aspects, either alone or in combination:

1. A method for evaluating and managing adoption maturity within a technology ecosystem, the method comprising: collecting, by one or more processors, one or more input data sets from a technology ecosystem, the one or more input data sets comprising at least a technical documentation data set, a well-architected framework (WAF) data set, and an enterprise specific data set; analyzing, by the one or more processors, the one or more input data sets to obtain a plurality of parameters associated with the one or more input data sets; evaluating, by the one or more processors, the plurality of parameters using a scoring system to determine one or more scores for one or more criteria of the technology ecosystem based on the plurality of parameters; and generating, by the one or more processors, an adoption maturity score for the technology ecosystem based on the one or more scores for the one or more criteria of the technology ecosystem, wherein the adoption maturity score represents an extent to which the technology ecosystem is optimized.

2. The method of aspect 1, further comprising: identifying, by the one or more processors, one or more software or hardware updates to the technology ecosystem based on the one or more scores for the one or more criteria that would increase the adoption maturity score; and implementing, by the one or more processors, the one or more software or hardware updates in the technology ecosystem.

3. The method of any of aspects 1-2, wherein the one or more input data sets further comprises a technical debt data set or a requirements data set.

4. The method of aspect 3, wherein collecting the one or more input data sets further comprises analyzing application architecture diagrams and process flows of the technical documentation data set against the well-architected framework data set and the requirements data set.

5. The method of any of aspects 1-4, wherein evaluating the one or more criteria to determine the one or more scores further include analysis of scalability, security, and other factors defining the adoption maturity score.

6. The method of any of aspects 1-5, further comprising: generating, by the one or more processors, a local adoption maturity score based on the one or more scores for the one or more criteria of the technology ecosystem for parameters associated with a particular business unit; and generating, by the one or more processors, an enterprise adoption maturity score based on the one or more scores for the one or more criteria of the technology ecosystem for parameters associated with the enterprise, wherein generating the adoption maturity score further comprises generating the adoption maturity score by combining the enterprise adoption maturity score and the local adoption maturity score.

7. The method of any of aspects 1-6, wherein analyzing the one or more input data sets to obtain a plurality of parameters includes: pre-processing, by the one or more processors, the one or more input data sets by applying the one or more input data sets to a trained machine learning model to classify information from the one or more input data sets into the plurality of parameters.

8. The method of any of aspects 1-7, wherein the technical documentation data set comprises one or more of: technical documents, code repositories, architecture diagrams, security postures, environment scans, or disaster recovery files.

9. The method of any of aspects 1-8, wherein generating the adoption maturity score includes: for each of the one or more criteria, applying, by the one or more processors, the criterion to a first machine learning model to generate a respective score for the criterion; and applying, by the one or more processors, the respective scores for the one or more criteria to a second machine learning model to generate the adoption maturity score.

10. The method of any of aspects 1-9, further comprising: integrating, by the one or more processors, human feedback for continuous learning and adjustment of an adoption maturity assessment process.

11. The method of any of aspects 1-10, wherein the adoption maturity score is a category selected from at least one of: a silver category, a gold category, a platinum category, or a diamond category.

12. The method of any of aspects 1-11, wherein the technology ecosystem is initially assigned the silver category and generating the adoption maturity score includes: generating, by the one or more processors, the adoption maturity score such that the technology ecosystem progresses to a higher category one stage at a time based on the one or more scores for the one or more criteria associated with the higher category.

13. The method of any of aspects 1-12, further comprising: applying, by the one or more processors, one or more of: the adoption maturity score, the one or more input data sets, the plurality of parameters, the one or more criteria, or the one or more scores for the one or more criteria to a generative artificial intelligence model configured to generate responses to user queries regarding the adoption maturity; and providing, by the one or more processors, a response to a user query regarding the adoption maturity via a chatbot.

14. A computer system for evaluating and managing adoption maturity within a technology ecosystem, comprising: one or more processors, and a tangible, non-transitory memory coupled to the one or more processors and storing executable instructions thereon that, when executed by the one or more processors, cause the computer system to: collect one or more input data sets from a technology ecosystem, the one or more input data sets comprising at least a technical documentation data set, a well-architected framework (WAF) data set, and enterprise specific data set; analyze the one or more input data sets to obtain a plurality of parameters associated with the one or more input data sets; evaluate the plurality of parameters using a scoring system to determine one or more scores for one or more criteria of the technology ecosystem based on the plurality of parameters; and generate an adoption maturity score for the technology ecosystem based on the one or more scores for the one or more criteria of the technology ecosystem, wherein the adoption maturity score represents an extent to which the technology ecosystem is optimized.

15. The computer system of aspect 14, wherein the instructions, when executed by the one or more processors, further cause the computer system to: identify one or more software or hardware updates to the technology ecosystem based on the one or more scores for the one or more criteria for the one or more criteria that would increase the adoption maturity score; and implement the one or more software or hardware updates in the technology ecosystem.

16. The computer system of any of aspects 14-15, wherein the instructions, when executed by the one or more processors, further cause the computer system to: generate a local adoption maturity score based on the one or more scores for the one or more criteria of the technology ecosystem for parameters associated with a particular business unit; and generate an enterprise adoption maturity score based on the one or more scores for the one or more criteria of the technology ecosystem for parameters associated with the enterprise, wherein the instructions to generate the adoption maturity score further causes the computer system to generate the adoption maturity score by combining the enterprise adoption maturity score and the local adoption maturity score.

17. The computer system of any of aspects 14-16, wherein the instructions to analyze the one or more input data sets to obtain a plurality of parameters further comprise instructions that, when executed by the one or more processors, further cause the computer system to: pre-process the one or more input data sets by applying the one or more input data sets to a trained machine learning model to classify information from the one or more input data sets into the plurality of parameters.

18. The computer system of any of aspects 14-17, wherein the instructions to generate the adoption maturity score further comprise instructions that, when executed by the one or more processors, further cause the computer system to: for each of the one or more criteria, apply the criterion to a first machine learning model to generate a respective score for the criterion; and apply the respective scores for the one or more criteria to a second machine learning model to generate the adoption maturity score.

19. A non-transitory computer-readable medium storing executable instructions for evaluating and managing adoption maturity within a technology ecosystem that, when executed by one or more processors, cause the one or more processors to: collect one or more input data sets from a technology ecosystem, the one or more input data sets comprising at least a technical documentation data set, a well-architected framework (WAF) data set, and enterprise specific data set; analyze the one or more input data sets to obtain a plurality of parameters associated with the one or more input data sets; evaluate the plurality of parameters using a scoring system to determine one or more scores for one or more criteria of the technology ecosystem based on the plurality of parameters; and generate an adoption maturity score for the technology ecosystem based on the one or more scores for the one or more criteria of the technology ecosystem,, wherein the adoption maturity score represents an extent to which the technology ecosystem is optimized.

20. The non-transitory computer-readable medium of aspect 19, wherein the instructions further cause the one or more processors to: identify one or more software or hardware updates to the technology ecosystem based on the one or more scores for the one or more criteria that would increase the adoption maturity score; and implement the one or more software or hardware updates in the technology ecosystem.

### Additional Considerations

The following considerations also apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

It should also be understood that, unless a term is expressly defined in this patent using the sentence “As used herein, the term” “is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for implementing the concepts disclosed herein, through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for evaluating and managing adoption maturity within a technology ecosystem, the method comprising:
collecting, by one or more processors, one or more input data sets from a technology ecosystem, the one or more input data sets comprising at least a technical documentation data set, a well-architected framework (WAF) data set, and an enterprise specific data set;
analyzing, by the one or more processors, the one or more input data sets to obtain a plurality of parameters associated with the one or more input data sets;
evaluating, by the one or more processors, the plurality of parameters using a scoring system to determine one or more scores for one or more criteria of the technology ecosystem based on the plurality of parameters; and
generating, by the one or more processors, an adoption maturity score for the technology ecosystem based on the one or more scores for the one or more criteria of the technology ecosystem, wherein the adoption maturity score represents an extent to which the technology ecosystem is optimized.

2. The method of claim 1, further comprising:
identifying, by the one or more processors, one or more software or hardware updates to the technology ecosystem based on the one or more scores for the one or more criteria that would increase the adoption maturity score; and
implementing, by the one or more processors, the one or more software or hardware updates in the technology ecosystem.

3. The method of claim 1, wherein the one or more input data sets further comprises a technical debt data set or a requirements data set.

4. The method of claim 3, wherein collecting the one or more input data sets further comprises analyzing application architecture diagrams and process flows of the technical documentation data set against the well-architected framework data set and the requirements data set.

5. The method of claim 1, wherein evaluating the one or more criteria to determine the one or more scores further include analysis of scalability, security, and other factors defining the adoption maturity score.

6. The method of claim 1, further comprising:
generating, by the one or more processors, a local adoption maturity score based on the one or more scores for the one or more criteria of the technology ecosystem for parameters associated with a particular business unit; and
generating, by the one or more processors, an enterprise adoption maturity score based on the one or more scores for the one or more criteria of the technology ecosystem for parameters associated with the enterprise,
wherein generating the adoption maturity score further comprises generating the adoption maturity score by combining the enterprise adoption maturity score and the local adoption maturity score.

7. The method of claim 1, wherein analyzing the one or more input data sets to obtain a plurality of parameters includes:
pre-processing, by the one or more processors, the one or more input data sets by applying the one or more input data sets to a trained machine learning model to classify information from the one or more input data sets into the plurality of parameters.

8. The method of claim 1, wherein the technical documentation data set comprises one or more of: technical documents, code repositories, architecture diagrams, security postures, environment scans, or disaster recovery files.

9. The method of claim 1, wherein generating the adoption maturity score includes:
for each of the one or more criteria, applying, by the one or more processors, the criterion to a first machine learning model to generate a respective score for the criterion; and
applying, by the one or more processors, the respective scores for the one or more criteria to a second machine learning model to generate the adoption maturity score.

10. The method of claim 1, further comprising:
integrating, by the one or more processors, human feedback for continuous learning and adjustment of an adoption maturity assessment process.

11. The method of claim 1, wherein the adoption maturity score is a category selected from at least one of: a silver category, a gold category, a platinum category, or a diamond category.

12. The method of claim 11, wherein the technology ecosystem is initially assigned the silver category and generating the adoption maturity score includes:
generating, by the one or more processors, the adoption maturity score such that the technology ecosystem progresses to a higher category one stage at a time based on the one or more scores for the one or more criteria associated with the higher category.

13. The method of claim 1, further comprising:
applying, by the one or more processors, one or more of: the adoption maturity score, the one or more input data sets, the plurality of parameters, the one or more criteria, or the one or more scores for the one or more criteria to a generative artificial intelligence model configured to generate responses to user queries regarding the adoption maturity; and
providing, by the one or more processors, a response to a user query regarding the adoption maturity via a chatbot.

14. A computer system for evaluating and managing adoption maturity within a technology ecosystem, comprising:
one or more processors, and
a tangible, non-transitory memory coupled to the one or more processors and storing executable instructions thereon that, when executed by the one or more processors, cause the computer system to:
collect one or more input data sets from a technology ecosystem, the one or more input data sets comprising at least a technical documentation data set, a well-architected framework (WAF) data set, and an enterprise specific data set;
analyze the one or more input data sets to obtain a plurality of parameters associated with the one or more input data sets;
evaluate the plurality of parameters using a scoring system to determine one or more scores for one or more criteria of the technology ecosystem based on the plurality of parameters; and
generate an adoption maturity score for the technology ecosystem based on the one or more scores for the one or more criteria of the technology ecosystem, wherein the adoption maturity score represents an extent to which the technology ecosystem is optimized.

15. The computer system of claim 14, wherein the instructions, when executed by the one or more processors, further cause the computer system to:
identify one or more software or hardware updates to the technology ecosystem based on the one or more scores for the one or more criteria for the one or more criteria that would increase the adoption maturity score; and
implement the one or more software or hardware updates in the technology ecosystem.

16. The computer system of claim 14, wherein the instructions, when executed by the one or more processors, further cause the computer system to:
generate a local adoption maturity score based on the one or more scores for the one or more criteria of the technology ecosystem for parameters associated with a particular business unit; and
generate an enterprise adoption maturity score based on the one or more scores for the one or more criteria of the technology ecosystem for parameters associated with the enterprise,
wherein the instructions to generate the adoption maturity score further cause the computer system to generate the adoption maturity score by combining the enterprise adoption maturity score and the local adoption maturity score.

17. The computer system of claim 14, wherein the instructions to analyze the one or more input data sets to obtain a plurality of parameters further comprise instructions that, when executed by the one or more processors, further cause the computer system to:
pre-process the one or more input data sets by applying the one or more input data sets to a trained machine learning model to classify information from the one or more input data sets into the plurality of parameters.

18. The computer system of claim 14, wherein the instructions to generate the adoption maturity score further comprise instructions that, when executed by the one or more processors, further cause the computer system to:
for each of the one or more criteria, apply the criterion to a first machine learning model to generate a respective score for the criterion; and
apply the respective scores for the one or more criteria to a second machine learning model to generate the adoption maturity score.

19. A non-transitory computer-readable medium storing executable instructions for evaluating and managing adoption maturity within a technology ecosystem that, when executed by one or more processors, cause the one or more processors to:
collect one or more input data sets from a technology ecosystem, the one or more input data sets comprising at least a technical documentation data set, a well-architected framework (WAF) data set, and enterprise specific data set;
analyze the one or more input data sets to obtain a plurality of parameters associated with the one or more input data sets;
evaluate the plurality of parameters using a scoring system to determine one or more scores for one or more criteria of the technology ecosystem based on the plurality of parameters; and
generate an adoption maturity score for the technology ecosystem based on the one or more scores for the one or more criteria of the technology ecosystem,, wherein the adoption maturity score represents an extent to which the technology ecosystem is optimized.

20. The non-transitory computer-readable medium of claim 19, wherein the instructions further cause the one or more processors to:
identify one or more software or hardware updates to the technology ecosystem based on the one or more scores for the one or more criteria that would increase the adoption maturity score; and
implement the one or more software or hardware updates in the technology ecosystem.
